(19) United States
(12) Patent Application Publication
(10) Pub. No.: US 2010/0243145 A1
(43) Pub. Date: Sep. 30, 2010

(54) BONDING METHOD AND BONDED STRUCTURE

(75) Inventors: Minehiro IMAMURA, Suwa (JP); Kazuhiro GOMI, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/729,491

(22) Filed: Mar. 23, 2010

(30) Foreign Application Priority Data
Mar. 26, 2009 (JP) 2009-077812

(51) Int. Cl. B32B 38/10

(52) U.S. Cl. 156/247

(57) ABSTRACT

A bonding method includes: preparing a first base material to have liquid repellency against a silicone material-containing liquid material; applying the liquid material to a surface of the first base material to form a liquid coating in a predetermined shape, and drying the liquid coating to obtain a bonding film with the predetermined shape; imparting energy to the bonding film to develop adhesion near a surface of the bonding film, and bonding the first base material to a second base material via the bonding film, and then separating the first and second base materials from each other to transfer the bonding film to the second base material; and imparting energy to the bonding film after the transfer to develop adhesion near a surface of the bonding film, and bonding the second base material to a third base material via the bonding film to obtain a bonded structure.

This application claims priority to Japanese Application No. 2009-077812 filed Mar. 26, 2009 which is hereby expressly incorporated by reference herein in its entirety.

### BACKGROUND

1. Technical Field

The present invention relates to bonding methods and bonded structures.

2. Related Art

Methods of forming a film on a substrate in patterns of a predetermined shape are known. For example, JP-A-2006-289226 discloses a method in which a liquid material that contains the film material is applied onto a substrate in a predetermined shape to form a patterned liquid coating, which is then dried to form a film in patterns of the predetermined shape.

The method of forming a patterned film using such liquid materials has application in bonding two substrates together, in which a bonding film containing a heat- or light-curable resin is formed on the substrate in a predetermined shape.

However, the method in which the liquid material is applied onto a substrate is problematic in that, depending on the wettability of the liquid material for the substrate, the liquid coating applied in a predetermined shape spreads over the substrate, and thus lowers the patterning accuracy of the resulting film.

### SUMMARY

An advantage of some aspects of the present invention is to provide a bonding method by which two substrates can be bonded to each other with a bonding film that has been patterned with high deposition accuracy, and a bonded structure including a bonding film bonded by the bonding method.

The foregoing advantage can be realized by the following aspects.

A bonding method according to an aspect of the invention includes:
(1) preparing a first base material having liquid repellency against a silicone material-containing liquid material at least near a surface, and a second base material and a third base material that are to be bonded to each other via a bonding film;
(2) applying the liquid material to a liquid repellency-imparted surface of the first base material to form a liquid coating in patterns of a predetermined shape, and drying the liquid coating to obtain a bonding film patterned into the predetermined shape;
(3) imparting energy to the bonding film to develop adhesion near a surface of the bonding film, and bonding the first base material and the second base material to each other via the bonding film, and then separating the first base material and the second base material from each other to transfer the bonding film from the first base material to the second base material; and
(4) imparting energy to the bonding film after the transfer to develop adhesion near a surface of the bonding film, and bonding the second base material and the third base material to each other via the bonding film to obtain a bonded structure of the second base material and the third base material.

In this way, the second base material and the third base material can be bonded to each other with the bonding film patterned with high deposition accuracy.

In a bonding method according to another aspect, it is preferable that, in step (2), the bonding film is formed on the second base material over substantially an entire surface to be bonded to the third base material via the bonding film.

In this way, the bonding by the bonding film can be further strengthened.

In a bonding method according to another aspect it is preferable that, in step (2), the bonding film is formed on the third base material over substantially an entire surface to be bonded to the second base material via the bonding film.

In this way, the bonding by the bonding film can be further strengthened.

In a bonding method according to another aspect it is preferable that, in step (2), the bonding film is formed on the second base material over substantially an entire surface to be bonded to the third base material via the bonding film.

In this way, the bonding by the bonding film can be further strengthened.

In a bonding method according to another aspect it is preferable that, in step (2), the liquid coating is formed by supplying the liquid material in droplets using a droplet discharge method.

With the droplet discharge method, the bonding film can be formed with improved deposition accuracy.

In a bonding method according to another aspect it is preferable that the droplet discharge method be an inkjet method by which the liquid material is discharged in droplets through a nozzle hole of an inkjet head using vibration of a piezoelectric element.

With the inkjet method, the liquid material can be supplied to a target region (position) in droplets with excellent positional accuracy. Further, because the size (volume) of the droplets can be adjusted with relative ease by appropriately setting parameters such as the vibration frequency of the piezoelectric element and the viscosity of the liquid material, the liquid coating can be reliably formed in a shape corresponding to the predetermined shape by reducing the size of the droplets, even when the predetermined shape has microscopic dimensions.

In a bonding method according to another aspect it is preferable that the predetermined shape correspond in shape to a position where bonding by the bonding film is desired.

In a bonding method according to another aspect it is preferable that the silicone material have a main backbone of polydimethylsiloxane, and that the main backbone is branched.

In this way, the branch chains of the silicone material tangle together to form the bonding film, and thus the resulting bonding film has particularly high film strength.

In a bonding method according to another aspect it is preferable that at least one of the methyl groups of the polydimethylsiloxane in the silicone material be substituted with a phenyl group.

In this way, the film strength of the bonding film can be further improved.

In a bonding method according to another aspect it is preferable that the silicone material include a plurality of silanol groups.

In this way, the hydroxyl group of the silicone material and the hydroxyl group of the polyester resin can reliably bind to each other, and the polyester-modified silicone material can be reliably synthesized by the dehydrocondensation reaction between the silicone material and the polyester resin.

Further, because the hydroxyl groups contained in the silanol groups of adjacent silicone materials bind together when the liquid coating is dried to obtain the bonding film, the resulting bonding film excels in film strength.

In a bonding method according to another aspect it is preferable that the silicone material be a polyester-modified silicone material obtained by a dehydrocondensation reaction with polyester resin.

In this way, the film strength of the bonding film can be further improved.

In a bonding method according to another aspect it is preferable that the polyester resin be the product of esterification reaction between saturated polybasic acid and polyalcohol.

In a bonding method according to another aspect it is preferable that, in steps (3) and (4), energy is imparted to the bonding film by plasma contacting the bonding film.

In this way, the bonding film can be activated in an extremely short time period (for example, on the order of several seconds), making it possible to produce the bonded structure in a short amount of time.

In a bonding method according to another aspect it is preferable that the plasma contact be performed under atmospheric pressure.

By performing the plasma contact under atmospheric pressure, or specifically in an atmospheric pressure plasma treatment, the environment surrounding the bonding film does not need to have a reduced pressure. Thus, for example, the methyl groups of the polydimethylsiloxane backbone in the bonding film-forming polyester-modified silicone material will not be unnecessarily cut when these methyl groups are subjected to cutting and removal by the action of the plasma to develop adhesion near the surface of the bonding film.

In a bonding method according to another aspect it is preferable that the plasma contact be performed by supplying a plasma gas to the bonding film, wherein the plasma gas is produced by introducing a gas between opposing electrodes under applied voltage between the electrodes.

In this way, the plasma can easily and reliably contact the bonding film, and adhesion can be reliably developed near the surface of the bonding film.

In a bonding method according to another aspect it is preferable that the second base material and the third base material are primarily formed of a silicon material, a metal material, or a glass material in portions brought into contact with the bonding film.

In this way, sufficient bond strength can be obtained without a surface treatment.

In a bonding method according to another aspect it is preferable that the second base material and the third base material be subjected in advance to a surface treatment in portions brought into contact with the bonding film, the surface treatment being performed to improve adhesion for the bonding film.

The surface treatment cleans and activates the bonding face of the base material, making it easier for the bonding film to chemically act on the bonding face. As a result, the bond strength between the bonding face of the base material and the bonding film can be improved.

In a bonding method according to another aspect it is preferable that the surface treatment be a plasma treatment or an ultraviolet ray irradiation treatment.

In this way, the surface of the base material can be particularly optimized for the bonding film formation.

In a bonding method according to another aspect it is preferable to further include subjecting the bonding film to a treatment that improves the bond strength between the second base material and the third base material, after the second base material and the third base material are bonded to each other.

In this way, the bond strength of the bonded structure can be further improved.

In a bonding method according to another aspect it is preferable that the treatment to improve the bond strength be performed by at least one of heating the bonding film, and exerting a compression force to the bonding film.

In this way, the bond strength of the bonded structure can be easily further improved.

A bonded structure according to an aspect of the invention is obtained by bonding the second base material and the third base material to each other via the bonding film formed by a bonding method of any of the foregoing aspects.

In this way, a highly reliable bonded structure can be obtained.

### BRIEF DESCRIPTION OF THE DRAWINGS

The invention will be described with reference to the accompanying drawings, wherein like numbers reference like elements.

FIG. 1 is a perspective view illustrating a droplet discharge apparatus used to apply a liquid material onto a first base material.

FIGS. 2A and 2B are diagrams illustrating a droplet discharge head of the droplet discharge apparatus illustrated in FIG. 1, in which FIG. 2A is a perspective view, and FIG. 2B is a cross sectional view.

FIGS. 3A to 3D are longitudinal sectional views explaining a First Embodiment of a bonding method.

FIGS. 4A to 4D are longitudinal sectional views explaining the First Embodiment of a bonding method.

FIGS. 5A to 5C are longitudinal sectional views explaining the First Embodiment of a bonding method.

FIG. 6 is a schematic diagram illustrating an atmospheric pressure plasma apparatus used for plasma contact with a bonding film.

FIGS. 7A to 7C are longitudinal sectional views explaining a Second Embodiment of a bonding method.

FIGS. 8A to 8C are longitudinal sectional views explaining the Second Embodiment of a bonding method.

FIG. 9 is a longitudinal sectional view illustrating an embodiment of an active-matrix organic emitting device using a bonded structure of an embodiment.

### DESCRIPTION OF EXEMPLARY EMBODIMENTS

Bonding methods and bonded structures are described in detail based on preferred embodiments represented by the accompanying drawings.

Prior to explaining bonding methods and bonded structures according to preferred embodiments, an example of a droplet discharge apparatus used to supply a liquid material with a bonding method is described first.

### Droplet Discharge Apparatus

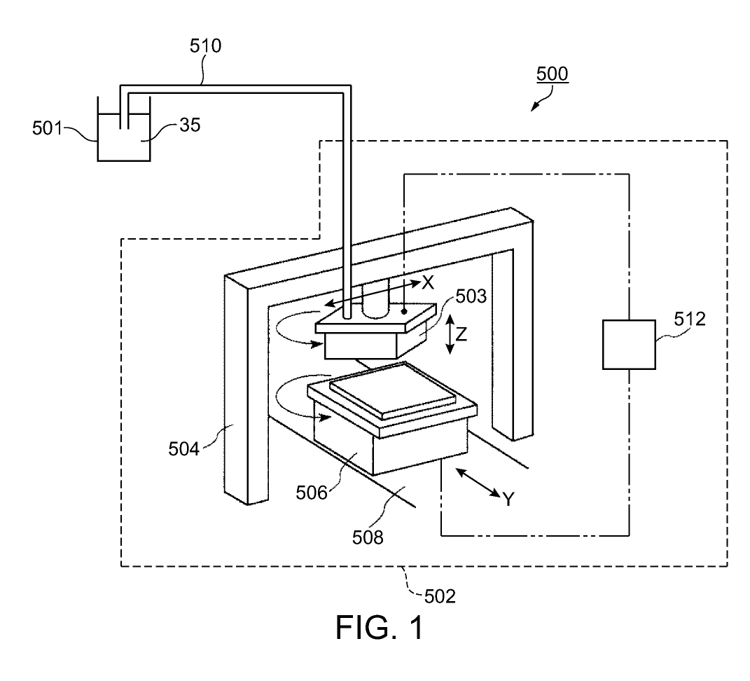

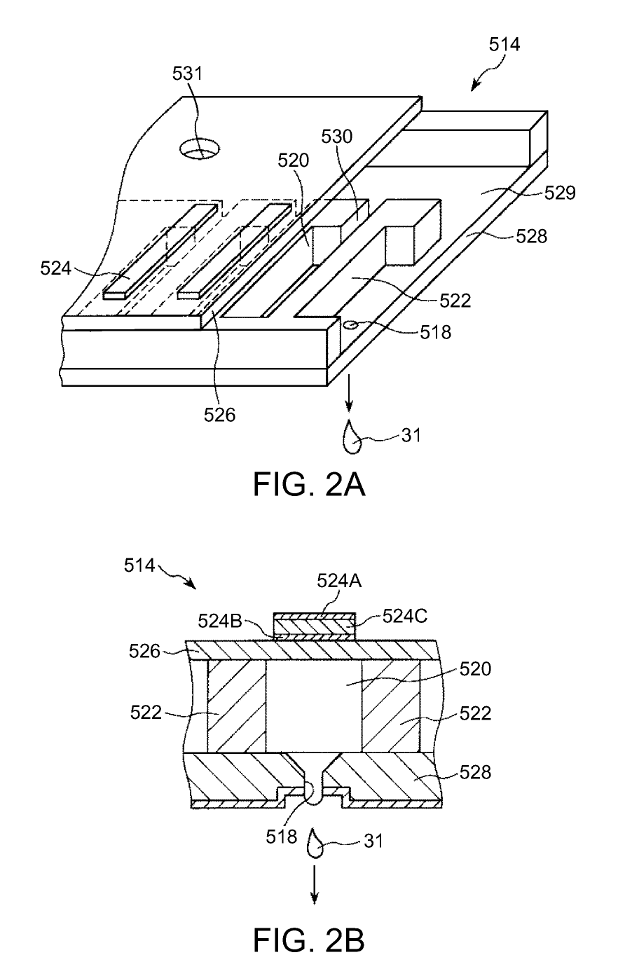

FIG. 1 is a perspective view of a droplet discharge apparatus used to apply a liquid material onto a first base material. FIGS. 2A and 2B are diagrams illustrating a droplet discharge head of the droplet discharge apparatus shown in FIG. 1, in which FIG. 2A is a perspective view, and FIG. 2B is a cross sectional view.

As illustrated in FIG. 1, a droplet discharge apparatus 500 used in the presently described step includes a tank 501 provided as a reservoir for a liquid material 35 used to form a bonding film 3 (described later), a tube 510, and a discharge scan section 502 to which the liquid material 35 is supplied from the tank 501 through the tube 510. The discharge scan section 502 includes a droplet discharger 503 provided with a droplet discharge head (inkjet head) 514, a first position control unit 504 (moving unit) that controls the position of the droplet discharger 503, a stage 506 that holds a first base material 21 on which the bonding film 3 is formed, a second position control unit 508 (moving unit) that controls the position of the stage 506, and a controller 512. The tank 501 and the droplet discharge head 514 of the droplet discharger 503 are joined to each other via the tube 510, and the liquid material 35 is supplied into the droplet discharge head 514 from the tank 501 by compressed air.

The controller (control unit) 512 is realized by a computer, for example, such as a microcomputer or a personal computer, with elements such as an arithmetic section and memory installed therein. The controller 512 receives signals (inputs) from an operation section (not illustrated), as needed.

Further, the controller 512 controls the operation (driving) of each section of the droplet discharge apparatus 500 according to preset programs, based on signals or some other form of information from the operation section.

The first position control unit 504 moves the droplet discharger 503 along the X-axis direction and the Z-axis direction orthogonal to the X-axis direction according to signals from the controller 512. Further, the first position control unit 504 functions to rotate the droplet discharger 503 about an axis parallel to the Z axis. In the present embodiment, the Z-axis direction is the direction parallel to the vertical direction (the direction of gravitational acceleration). The second position control unit 508 moves the stage 506 along the Y-axis direction orthogonal to the X- and Z-axis directions according to signals from the controller 512. Further, the second position control unit 508 functions to rotate the stage 506 about an axis parallel to the Z axis.

The stage 506 has a flat surface parallel to the X- and Y-axis directions. Further, the stage 506 is configured so that the first base material 21 to which the liquid material 35 is applied to form the bonding film 3 can be fastened or held on the flat surface.

As described above, the droplet discharger 503 is moved by the first position control unit 504 along the X-axis direction. The stage 506 is moved by the second position control unit 508 along the Y-axis direction. That is, the first position control unit 504 and the second position control unit 508 change the position of the droplet discharge head 514 relative to the stage 506 (relative movement between the droplet discharger 503 and the first base material 21 held on the stage 506).

The controller 512 is configured to receive discharge data indicative of the relative discharge position of the liquid material 35 from an external information processor.

To supply the liquid material 35 onto the first base material 21, the liquid material 35 is discharged onto the first base material 21 by the relative scan of the droplet discharge head 514 and the first base material 21. Specifically, the second position control unit 508 is activated to move the stage 506 with the first base material 21 along the Y-axis direction. As the stage 506 passes underneath the droplet discharger 503, droplets (ink droplets) 31 of the liquid material 35 are discharged (spit) onto a film forming region 41 of the first base material 21 through nozzles 518 of the droplet discharge head 514 of the droplet discharger 503. In the following description, this operation is also referred to as the “apply scan (main scan between the droplet discharge head 514 and the first base material 21).”

In the step of supplying the liquid material 35 onto the first base material 21, the apply scan (scan) is generally performed multiple times. The apply scan, however, may be performed only once.

In the present embodiment, the droplet discharge head 514 is realized by an inkjet head, as illustrated in FIGS. 2A and 2B. Specifically, the droplet discharge apparatus of the present embodiment is an inkjet apparatus.

The droplet discharge head 514 includes a vibrating plate 526 and a nozzle plate 528. Between the vibrating plate 526 and the nozzle plate 528 is a liquid pool 529 where the liquid material 35 supplied from the tank 501 through the tube 510 and a hole 531 is stored at all times.

Further, a plurality of barrier ribs 522 is disposed between the vibrating plate 526 and the nozzle plate 528. The region surrounded by a pair of barrier ribs 522 between the vibrating plate 526 and the nozzle plate 528 defines a cavity (ink chamber) 520. Because the cavity 520 is provided corresponding to the nozzle 518, the cavities 520 are provided as many as the nozzles 518. The liquid material 35 is supplied into the cavity 520 from the liquid pool 529 through an inlet 530 formed between a pair of barrier ribs 522.

Vibrators 524 are provided on the vibrating plate 526, respectively corresponding to the cavities 520. Each vibrator 524 includes a piezo element (piezoelectric element) 524C as the driving element, and a pair of electrodes 524A and 524B formed on the both sides of the piezo element 524C. A drive voltage (signal) is applied (supplied) across the electrodes 524A and 524B to cause vibration in the piezo element 524C and in turn in the vibrating plate 526, thus discharging the liquid material through the corresponding nozzle 518 in the form of droplets 31.

Here, the ejection amount (droplet amount) for each discharge operation of the liquid material 35 through the nozzle 518 can be adjusted by adjusting the drive voltage (for example, the magnitude of the drive voltage).

Note that the nozzle 518 is shaped to discharge the liquid material 35 along the Z-axis direction.

The controller 512 may be adapted to apply drive voltage independently to the vibrators 524. Specifically, the ejection amount for each discharge operation of the liquid material 35 through the nozzle 518 may be controlled for each nozzle 518 according to the signal from the controller 512, specifically the drive voltage. Further, the controller 512 may be adapted to control the nozzles 518 in such a manner that some of the nozzles 518 undergo the discharge operation while the others do not during the apply scan.

Note that each region including the nozzle 518, the corresponding cavity 520, and the corresponding vibrator 524 defines an ejecting section. The ejecting sections are therefore provided as many as the nozzles 518 in the droplet discharge head 514.

The droplet discharge apparatus 500 can be used to supply the liquid material 35 onto the first base material 21 in the form of droplets 31, enabling the liquid material 35 to be supplied to a desired position on a bonding face (top surface) 210 of the first base material 21. This ensures formation of a liquid coating 30 and thus the bonding film 3 on the first base material 21 in a shape corresponding to the film forming region 41. In other words, the liquid coating 30 (bonding film 3) can be reliably formed on the first base material 21 in patterns of a predetermined shape.

Note that the droplet discharge head 514 may use an electrostatic actuator as the driving element, instead of the piezo element. Further, the droplet discharge head 514 may be adapted to use a thermoelectric converting element as the driving element, and operated according to the bubble jet scheme to discharge the liquid material 35 by the thermal expansion of material, using the thermoelectric converting element.

In a bonding method according to an embodiment of the invention, the droplet discharge apparatus can be used to form the bonding film 3 on the first base material 21 in patterns of a predetermined shape. The bonding film so formed on the first base material 21 is then transferred onto a second base material 22 to enable bonding of the second base material 22 with a third base material 23.

Bonding methods according to embodiments of the invention are described below.

### Bonding Methods

A bonding method according to an embodiment of the invention includes:
a first step of preparing a first base material 21 that has liquid repellency against a silicone material-containing liquid material 35 at least near a surface, and a second base material 22 and a third base material 23 that are to be bonded to each other via a bonding film 3;
a second step of applying the liquid material 35 to the liquid repellency-imparted surface of the first base material 21 to form a liquid coating 30 in patterns of a predetermined shape, and drying the liquid coating 30 to obtain a bonding film 3 patterned into the predetermined shape;
a third step of imparting energy to the bonding film 3 to develop adhesion near a surface of the bonding film 3, and bonding the first base material 21 and the second base material 22 to each other via the bonding film 3, and then separating the first base material 21 and the second base material 22 from each other to transfer the bonding film 3 from the first base material 21 to the second base material 22; and
a fourth step of imparting energy to the transferred bonding film 3 to develop adhesion near a surface of the bonding film 3, and bonding the second base material 22 and the third base material 23 to each other via the bonding film 3 to obtain a bonded structure 1 of the second base material 22 and the third base material 23.

According to this method, the bonding film 3 using a silicone raw material can be formed in a target region of the first base material 21 in patterns of a predetermined shape with high deposition accuracy. The bonding film 3 can then be transferred to the second base material 22 to enable the base materials 22 and 23 to be strongly bonded to each other by the adhesion developed near the surface of the bonding film 3.

As used herein, the “predetermined shape” refers to the shape corresponding to the region where bonding by the bonding film 3 is desired. In the present embodiment, the “predetermined shape” is the shape corresponding to the film forming region 41 on bonding faces 220 and 230 of the second base material 22 and the third base material 23 (described later), respectively.

The following describes a First Embodiment of a bonding method of the invention step by step.

### First Embodiment

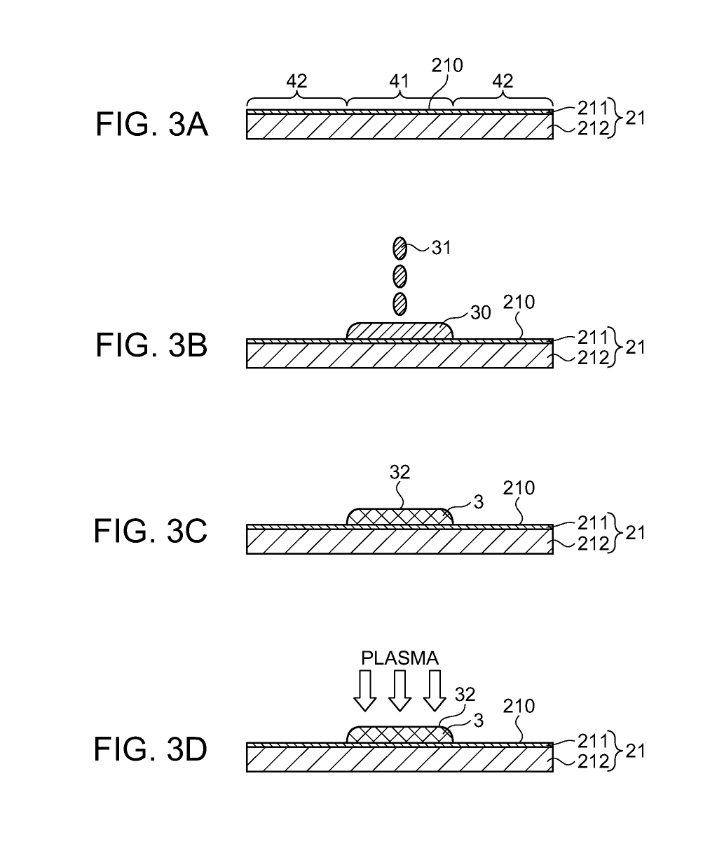

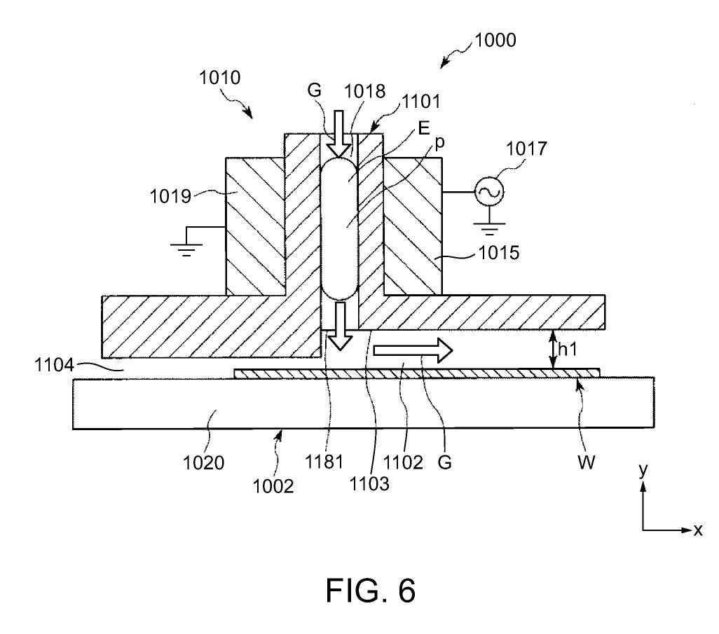

FIGS. 3A to 3D, FIGS. 4A to 4D, and FIGS. 5A to 5C are drawings (longitudinal sections) explaining the First Embodiment of a bonding method of the invention. FIG. 6 is a schematic diagram showing a structure of an atmospheric pressure plasma apparatus used for plasma contact with the bonding film. In the following, the upper and lower sides of FIGS. 3A to 3D, FIGS. 4A to 4D, FIGS. 5A to 5C, and FIG. 6 will be referred to as “upper” and “lower”, respectively.

A bonding method of the present embodiment is a method in which the bonding film 3 formed on the first base material 21 in patterns of a predetermined shape is transferred onto the second base material 22, and then the second base material 22 and the third base material 23 are bonded to each other via the bonding film 3.

Step 1: First, the first base material 21 that has liquid repellency near a surface, and the second base material 22 and the third base material 23 that are to be bonded to each other via the bonding film 3 are prepared (first step).

The first base material 21 may have any configuration as long as it has liquid repellency near a surface thereof. For example, the first base material 21 may be one provided with a liquid repellent film 211 on an upper surface of a base 212, as illustrated in FIG. 3A.

The liquid repellent film 211 may be, for example, a film of a fluorine-based material, or a monomolecular film formed of a coupling agent that contains a fluorine atom.

Specific examples of fluorine-based organic material among the fluorine-based material include polytetrafluoroethylene (PTFE), a tetrafluoroethyleneperfluoroalkyl vinyl ether copolymer (PFA), an ethylenetetrafluoroethylene copolymer (ETFE), a perfluoroethylenepropene copolymer (FEP), and an ethylenechlorotrifluoroethylene copolymer (ECTFE). Specific examples of fluorine-based inorganic material include potassium fluorotitanate, potassium fluorosilicate, potassium fluorozirconate, and hydrofluorosilicic acid.

Examples of the coupling agent that contains a fluorine atom include (tridecafluoro-1,1,2,2-tetrahydro-octyl)triethoxysilane, (tridecafluoro-1,1,2,2-tetrahydro-octyl)trimethoxysilane, (tridecafluoro-1,1,2,2-tetrahydro-octyl)trichlorosilane, trifluoropropyltrimethoxysilane, and γ-glycidoxypropyltrimethoxysilane.

The material of the base 212 is not particularly limited, and the following materials can be used, for example. Polyolefins such as polyethylene, polypropylene, ethylene-propylene copolymer, ethylene-acrylic ester copolymer, ethylene-acrylic acid copolymer, polybutene-1, and ethylene-vinyl acetate copolymer (EVA); polyesters such as cyclic polyolefin, modified polyolefin, polyvinyl chloride, polyvinylidene chloride, polystyrene, polyamide, polyimide, polyamideimide, polycarbonate, poly-(4-methylpentene-1), ionomer, acryl-based resin, polymethylmethacrylate(PMMA), acrylonitrile-butadiene-styrene copolymer (ABS resin), acrylonitrile-styrene copolymer (AS resin), butadiene-styrene copolymer, polyoxymethylene, polyvinyl alcohol (PVA), ethylene-vinyl alcohol copolymer (EVOH), polyethylene terephthalate (PET), polyethylene naphthalate, polybutylene terephthalate (PBT), and polycyclohexaneterephthalate (PCT); polyether; polyetherketone (PEK); polyether ether ketone (PEEK); polyetherimide; polyacetal (POM); polyphenylene oxide; modified polyphenylene oxide; polysulfone; polyether sulfone; polyphenylene sulfide; polyallylate; aromatic polyester (liquid crystal polymer); polytetrafluoroethylene; polyvinylidene fluoride; resin-based materials such as fluoro-based resin, various thermoplastic elastomers (for example, styrene-based, polyolefin-based, polyvinyl chloride-based, polyurethane-based, polyester-based, polyamide-based, polybutadiene-based, trans-polyisoprene-based, fluororubber-based, and chlorinated polyethylene-based), epoxy resin, phenol resin, urea resin, melamine resin, aramid-based resin, unsaturated polyester, silicone resin, and polyurethane, or copolymers, blends, and polymer alloys containing these as the main constituent; metals such as Fe, Ni, Co, Cr, Mn, Zn, Pt, Au, Ag, Cu, Pd, Al, W, Ti, V, Mo, Nb, Zr, Pr, Nd, and Sm, or alloys containing these metals; metal-based materials such as carbon steel, stainless steel, indium tin oxide (ITO), and gallium arsenide; silicon-based materials such as monocrystalline silicon, polycrystalline silicon, and amorphous silicon; glass-based materials such as silicate glass (fused quartz), alkali silicate glass, soda-lime glass, potassium-lime glass, lead (alkali) glass, barium glass, and borosilicate glass; ceramic-based materials such as alumina, zirconia, MgAl₂O₄, ferrite, silicon nitride, aluminum nitride, boron nitride, titanium nitride, silicon carbide, boron carbide, titanium carbide, and tungsten carbide; carbon-based materials such as graphite; and composite materials combining one or more kinds of these materials.

The second base material 22 and the third base material 23 are appropriately selected from materials that are to be bonded to each other. The materials are not particularly limited, and those exemplified above as the base 212 can be used, for example.

The second base material 22 and the third base material 23 may be surface-treated by, for example, a plating treatment such as Ni plating, a passivation treatment such as chromate treatment, or a nitriding treatment.

The materials of the second base material 22 and the third base material 23 may be the same as each other or different from each other.

Preferably, the second base material 22 and the third base material 23 have substantially the same coefficient of thermal expansion. With substantially the same coefficient of thermal expansion, stress due to thermal expansion does not easily occur at the bonded interface of the second base material 22 and the third base material 23 when these materials are bonded together. This will prevent detachment in the bonded structure 1 ultimately produced.

Note that, as will be described later, the second base material 22 and the third base material 23 can be strongly bonded together with high dimensional accuracy through controlled bonding conditions in a later step (described later), even when the coefficients of thermal expansion are different.

Preferably, the base materials 22 and 23 have different rigidities. This enables the base materials 22 and 23 to be bonded even more strongly.

Further, at least one of the base materials 22 and 23 is preferably made of resin material. Being flexible, resin materials relieve the stress (for example, stress due to thermal expansion) generated at the bonded interface of the base materials 22 and 23 when these materials are bonded together. Because the bonded interface is not easily destroyed, the bonded structure 1 can be provided with high bond strength.

From this perspective, it is preferable that at least one of the base materials 22 and 23 is flexible. In this way, the bond strength of the bonded structure 1 can be further improved. When the base materials 22 and 23 are both flexible, the bonded structure 1 will be flexible as a whole, and thus will be highly functional.

The base materials 22 and 23 can have any shape, as long as they have a surface that can support the bonding film 3. For example, the base materials 22 and 23 may be in the form of plates (layers), lumps (blocks), or rods.

In the present embodiment, as illustrated in FIGS. 3A to 3D to FIGS. 5A to 5C, the base materials 22 and 23 are plate-like in shape. This makes the base materials 22 and 23 easily bendable, and the base materials 22 and 23 sufficiently undergo deformation in conformity with each other when stacked together. This improves the adhesion between the base materials 22 and 23 stacked together, and the bond strength of the bonded structure 1 produced.

Further, the bending of the base materials 22 and 23 is expected to relieve, to some extent, the stress that generates at the bonded interface.

The average thickness of the base materials 22 and 23 is not particularly limited, and each has an average thickness of preferably about 0.01 to 10 mm, more preferably about 0.1 to 3 mm.

If desired, a surface treatment may be performed to improve adhesion to the bonding film 3 bonded to the bonding faces 220 and 230 of the second base material 22 and the third base material 23. The surface treatment cleans and activates the bonding faces 220 and 230, making it easier for the bonding film 3 to chemically act on the bonding faces 220 and 230. As a result, the bond strength between the bonding faces 220 and 230 and the bonding film 3 can be improved when the bonding film 3 is bonded to the bonding faces 220 and 230 in a subsequent step (described later).

The surface treatment includes, but is not particularly limited to, for example, physical surface treatment such as sputtering and a blast treatment; plasma treatment using, for example, oxygen plasma or nitrogen plasma; chemical surface treatment such as corona discharge, etching, electron ray irradiation, ultraviolet ray irradiation, and ozone exposure; and combinations of these.

When the second base material 22 and the third base material 23 subjected to surface treatment are made of a resin material (polymeric material), treatments such as corona discharge and nitrogen plasma treatment are particularly suitable.

When the surface treatment is plasma treatment or ultraviolet ray irradiation in particular, the bonding faces 220 and 230 can be cleaned and activated more efficiently. As a result, the bond strength between the bonding faces 220 and 230 and the bonding film 3 can be further improved.

Depending on the material of the second base material 22 and the third base material 23, sufficient bond strength for the bonding film 3 can be obtained without the surface treatment. Examples of such materials for the second base material 22 and the third base material 23 include materials containing primarily, for example, various metal-based materials, silicon-based materials, and glass-based materials, such as those exemplified above.

The second base material 22 and the third base material 23 made of such materials are coated with an oxide film on the surface, and hydroxyl groups are attached to the surface of the oxide film. Thus, with the second base material 22 and the third base material 23 coated with such an oxide film, the bond strength between the bonding faces 220 and 230 of the second base material 22 and the third base material 23 and the bonding film 3 can be improved without the surface treatment.

Note that, in this case, the second base material 22 and the third base material 23 are not necessarily required to be entirely made of such material, and the material may be used in at least portions near the bonding faces 220 and 230 in the film forming region 41 where the bonding film 3 is formed.

Instead of surface treatment, a coating layer may be formed in advance on the bonding faces 220 and 230 of the second base material 22 and the third base material 23.

The coating layer may have any function. For example, the coating layer may serve to improve adhesion to the bonding film 3, provide a cushioning effect (shock-absorbing function), or relieve stress concentration. By bonding the bonding film 3 to the coating layer, the reliability of the bonded structure 1 can be improved.

Examples of the material of the coating layer include: metal-based material such as aluminum and titanium; oxide-based material such as metal oxide and silicon oxide; nitride-based material such as metal nitride and silicon nitride; carbon-based material such as graphite and diamond-like carbon; self-organizing film material such as a silane coupling agent, a thiol-based compound, metal alkoxide, and a metal-halogen compound; and resin-based material such as a resin-based adhesive, a resin film, a resin coating, various rubber materials, and various elastomers. These materials may be used in combinations of one or more.

Among the coating layers made of these materials, a coating layer made of oxide-based material is particularly effective in terms of improving the bond strength between the bonding film 3 and the second and third base materials 22 and 23.

Note that the surface treatment and the formation of the coating layer are optional, and may be omitted when high bond strength is not desired.

Step 2: Next, the liquid material 35 containing a silicone material is applied to the surface of the first base material 21 on the side of the liquid repellent film 211, so as to form the liquid coating 30 in patterns of a predetermined shape, and the liquid coating 30 is dried to obtain the bonding film 3 patterned into the predetermined shape (second step).

This step is described below in detail.

2-1: The liquid material 35 containing a silicone material is supplied in droplets 31 to the bonding face 210 of the first base material 21 on the side of the liquid repellent film 211, using, for example, the droplet discharge method with the droplet discharge apparatus 500.

In this way, the droplets 31 are selectively supplied to the film forming region 41 of the bonding face 210 illustrated in FIG. 3A, avoiding a film devoid region 42 of the bonding face 210. As a result, as illustrated in FIG. 3B, the liquid coating 30 is formed on the first base material 21 in patterns of the shape of the film forming region 41, i.e., in patterns of a predetermined shape.

In the present embodiment, the liquid material 35 is selectively applied (supplied) to the film forming region 41 of the bonding face 220 using the droplet discharge method of supplying the liquid material 35 in droplets 31, using the droplet discharge apparatus 500.

By supplying the liquid material 35 with the position selectivity using the droplet discharge method, the liquid material 35 will not be wasted. Further, the number of steps to form the bonding film 3, and the time and cost of manufacturing can be reduced compared with, for example, the patterning of the film with the use of a resist layer formed as a mask on the substrate.

Further, in the present embodiment, the droplet discharge method is an inkjet method that uses the droplet discharge head 514 as the inkjet head. The inkjet method enables the liquid material 35 to be supplied to a target region (position) in the form of droplets 31 with excellent position accuracy. Further, because the size (volume) of the droplets 31 can be adjusted with relative ease by appropriately setting parameters such as the vibration frequency of the piezo element 524C and the viscosity of the liquid material 35, the liquid coating 30 can be reliably formed in a shape corresponding to the film forming region 41 by reducing the size of the droplets 31, even when the film forming region 41 has microscopic dimensions.

The viscosity (25° C.) of the liquid material 35 is preferably in the range of generally about 0.5 to 200 mPa·s, more preferably about 3 to 20 mPa·s. With the viscosity of the liquid material 35 falling in these ranges, the droplets can be discharged more stably, and the droplets 31 can be discharged in shapes with which the film forming region 41 of even microscopic dimensions can be delineated. Further, with the foregoing viscosity ranges, the liquid material 35 contains the silicone material in an amount sufficient to form the bonding film when the liquid coating 30 formed from the liquid material 35 is dried in the next step 2-2.

Further, the amount of each droplet 31 (one droplet of the liquid material 35) can be set to, on average, about 0.1 to 40 pL, practically about 1 to 30 pL, provided that the viscosity of the liquid material 35 is in the foregoing ranges. In this way, the dot diameter of the droplets 31 supplied onto the bonding face 220 will be small, ensuring formation of the bonding film 3 of even microscopic dimensions.

Further, by appropriately setting the amount of the droplets 31 supplied to the film forming region 41 of the bonding face 220, the thickness of the bonding film 3 can be controlled relatively easily.

In an embodiment of the invention, liquid repellency is imparted to the bonding face 210 to which the liquid material 35 is applied (supplied) in the form of droplets 31. In this way, spreading of the droplets 31 on the bonding face 210 can be appropriately suppressed or prevented upon application of the droplets 31 to the bonding face 210. Accordingly, the liquid coating 30 formed on the bonding face 210 retains the shape of the film forming region 41 with excellent patterning accuracy.

The wettability of the liquid coating 30 with respect to the bonding face 210 can be represented by, for example, the contact angle of the liquid coating 30 with respect to the bonding face 210. The contact angle is preferably about 80 to 110°, more preferably about 85 to 100°. The foregoing effects can be exhibited more prominently by appropriately selecting the type of the liquid material 35 and the liquid repellent film 211 so as to satisfy such relationships.

The liquid material 35 discharged in droplets 31 contains a silicone material. However, when the silicone material is available in liquid form and has a desired viscosity range alone, the silicone material can be used directly as the liquid material 35. Further, when the silicone material is available in solid or high-viscosity liquid form alone, a solution or dispersion of the silicone material can be used as the liquid material 35.

Examples of the solvent or dispersion medium used to dissolve or disperse the silicone material include inorganic solvents such as ammonia, water, hydrogen peroxide, carbon tetrachloride, and ethylene carbonate, and various organic solvents including: ketone-based solvents such as methyl ethyl ketone (MEK) and acetone; alcohol-based solvents such as methanol, ethanol, and isobutanol; ether-based solvents such as diethylether and diisopropylether; cellosolve-based solvents such as methyl cellosolve; aliphatic hydrocarbon-based solvents such as hexane and pentane; aromatic hydrocarbon-based solvents such as toluene, xylene, and benzene; aromatic heterocyclic compound-based solvents such as pyridine, pyrazine, and furan; amide-based solvents such as N,N-dimethylformamide (DMF); halogen compound-based solvents such as dichloromethane and chloroform; ester-based solvents such as ethyl acetate and methyl acetate; sulfur compound-based solvents such as dimethyl sulfoxide (DMSO) and sulfolane; nitrile-based solvents such as acetonitrile, propionitrile, and acrylonitrile; and organic acid-based solvents such as formic acid and trifluoroacetic acid. Mixed solvents containing these can also be used.

The silicone material is a material contained in the liquid material 35, and that is the main constituent of the bonding film 3 formed by drying the liquid material 35 in the next step 2-2.

The “silicone material” is a compound having a polyorganosiloxane backbone, in which the main backbone (main chain) is primarily generally of organosiloxane repeating units, and includes at least one silanol group. The silicone material may be of a branched structure including a branch in the main chain, or may be in cyclic form including a cyclic main chain, or may have a straight-chain structure in which the ends of the main chain are not joined.

For example, in a compound including the polyorganosiloxane backbone, the organosiloxane unit at the terminal portion has a structure unit represented by general formula (1) below. At the linking portion and the branched portion, the organosiloxane unit has structure units represented by general formulae (2) and (3) below, respectively.

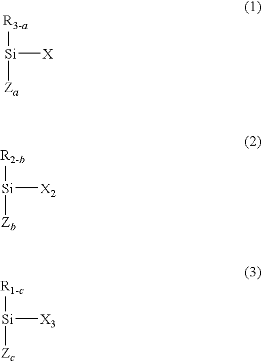

In the formulae, each R independently represents a substituted or unsubstituted hydrocarbon group, each Z independently represents a hydroxyl group or a hydrolyzable group, each X represents a siloxane residue, “a” represents an integer of 1 to 3, “b” represents 0 or an integer of 1 to 2, and “c” represents 0 or 1.

The siloxane residue is a substituent forming a siloxane bond with the silicon atom of the adjacent structure unit via an oxygen atom, specifically an —O—(Si) structure (where Si is the silicon atom of the adjacent structure unit).

In such a silicone material, the polyorganosiloxane backbone is preferably branched; specifically, it preferably has the structure unit represented by general formula (1), (2), or (3). A compound having such a branched polyorganosiloxane backbone (hereinafter, also referred to as “branched compound”) is a compound whose main backbone (main chain) is of primarily organosiloxane repeating units, and in which the organosiloxane repeating units branch out in a middle of the main chain, and in which the ends of the main chains are not joined.

With the branched compound, the branch chains of the compound in the liquid material 35 tangle together to form the bonding film 3 in the next step 2-2, and thus the resulting bonding film 3 has a particularly superior film strength.

Note that in general formulae (1) to (3), examples of the R group (substituted or unsubstituted hydrocarbon group) include: alkyl groups such as a methyl group, an ethyl group, and a propyl group; cycloalkyl groups such as a cyclopentyl group and a cyclohexyl group; aryl groups such as a phenyl group, a tolyl group, and a biphenylyl group; and aralkyl groups such as a benzyl group and a phenylethyl group. Some of or all of the hydrogen atoms attached to the carbon atoms of these groups may be substituted with, for example, (I) halogen atoms such as a fluorine atom, a chlorine atom, and a bromine atom, (II) epoxy groups such as a glycidoxy group, (III) (meth)acryloyl groups such as a methacryl group, or (IV) anionic groups such as a carboxyl group and a sulfonyl group.

When the Z group is a hydrolyzable group, examples of the hydrolyzable group include: alkoxy groups such as a methoxy group, an ethoxy group, a propoxy group, and a butoxy group; ketoxime groups such as a dimethyl ketoxime group and a methyl ethyl ketoxime group; acyloxy groups such as an acetoxy group; and alkenyloxy groups such as an isopropenyloxy group and an isobutenyloxy group.

The branched compound has a molecular weight of preferably about 1×10⁴ to 1×10⁶, more preferably about 1×10⁵ to 1×10⁶. With the molecular weight set in these ranges, the viscosity of the liquid material 35 can be set in the foregoing ranges with relative ease.

It is preferable that the branched compound include a plurality of silanol groups (hydroxyl groups) within the compound. Specifically, in the structure units represented by general formulae (1) to (3), it is preferable to include a plurality of Z groups, and that these Z groups are hydroxyl groups. This ensures the bonding between the hydroxyl group of the branched compound and the hydroxyl group of the polyester resin, thus ensuring the synthesis of the polyester-modified silicone material obtained by the dehydrocondensation reaction between the branched compound and the polyester resin (described later). Further, in obtaining the bonding film 3 by drying the liquid coating 30 in the next step 2-2, the hydroxyl groups contained in the residual silanol groups of the silicone material (or more specifically the branched compound) bind together, improving the film strength of the resulting bonding film 3.

The hydrocarbon group joined to the silicon atom of the silanol group is preferably a phenyl group. Specifically, the R group in the structure units of general formulae (1) to (3) in which the Z group is a hydroxyl group is preferably a phenyl group. This further improves the reactivity of the silanol group, and thus facilitates the bonding between the hydroxyl groups of the adjacent branched compounds. Further, by substituting at least one of the methyl groups of the branched compound with a phenyl group to include the phenyl group in the resulting bonding film 3, the film strength of the bonding film 3 can be further improved.

The hydrocarbon group joined to the silicon atom without a silanol group is preferably a methyl group. Specifically, the R group in the structure units of general formulae (1) to (3) in which the Z group is not present is preferably a methyl group. A compound in which the R group in the structure units of general formulae (1) to (3) in which the Z group is not present is a methyl group is available relatively easily and inexpensively. Further, in later steps 3 and 4, the methyl group can be easily cut by imparting energy to the bonding film 3, and adhesion can be reliably developed to the bonding film 3. Such compounds are therefore suitable as the branched compound (silicone material).

Taking these into consideration, a compound represented by general formula (4) below can be suitably used as the branched compound, for example.

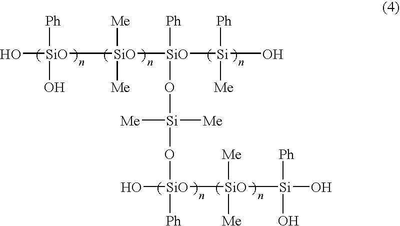

In the formula, n independently represents 0 or an integer of 1 or more.

The branched compound has a relatively high flexibility. Thus, in obtaining the bonded structure 1 by bonding the second base material 22 and the third base material 23 via the bonding film 3 in a later step 4, the stress due to the thermal expansion between the base materials 22 and 23 can be reliably relieved even when, for example, different materials are used for the second base material 22 and the third base material 23. This ensures that detachment does not occur in the bonded structure 1 produced.

Because the branched compound excels in chemical resistance, it can be effectively used for the bonding of members exposed to chemicals or the like for extended time periods. Specifically, for example, the bonding film 3 can reliably improve the durability of the droplet discharge head of industrial inkjet printers when used for the bonding in the manufacture of the head that uses organic-based ink, which easily corrodes the resin material. Further, because the branched compound also excels in heat resistance, it can be effectively used for the bonding of members exposed to high temperature.

The silicone material is preferably polyester-modified silicone material.

As used herein, the “polyester-modified silicone material” is the material obtained by the dehydrocondensation reaction between silicone material and polyester resin.

The “polyester resin” is one obtained by the esterification reaction between saturated polybasic acid and polyalcohol, and those including at least two hydroxyl groups per molecule are suitably used.

The condensation reaction between the polyester resin and the silicone material causes a dehydrocondensation reaction between the hydroxyl group of the polyester resin and the silanol group (hydroxyl group) of the silicone material to give the polyester-modified silicone material in which the polyester resin is joined to the silicone material.

The saturated polybasic acid is not particularly limited. Examples include isophthalic acid, terephthalic acid, anhydrous phthalic acid, and adipic acid, which may be used in combinations of one or more.

Examples of polyalcohol include ethylene glycol, diethylene glycol, propylene glycol, glycerine, and trimethylolpropane, which may be used in combinations of one or more.

The contents of the saturated polybasic acid and the polyalcohol in the esterification reaction are set so that the hydroxyl groups of the polyalcohol exceed the carboxyl groups of the saturated polybasic acid in number. In this way, the synthesized polyester resin comes to include at least two hydroxyl groups per molecule.

The polyester resin preferably includes a phenylene group within the molecule. When the bonding film 3 is formed with the polyester-modified silicone material that contains such polyester resin, the resulting bonding film 3 exhibits particularly superior film strength because of the phenylene group contained in the polyester resin.

Taking these into consideration, a compound represented by general formula (5) below can be suitably used as the polyester resin, for example.

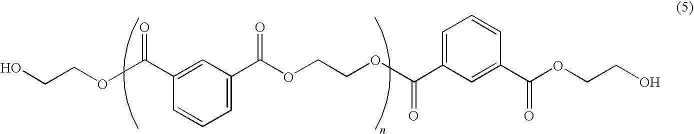

In the formula, n represents 0 or an integer of 1 or more.

The polyester-modified silicone material including such polyester resin generally exists in a state in which the polyester resin is exposed on the polyorganosiloxane backbone of a helical structure. Thus, in obtaining the bonding film 3 by drying the liquid coating 30 in the next step 2-2, the polyester resin in the polyester-modified silicone material has a greater chance to contact with each other between adjacent molecules. As a result, the polyester resin tangles together in the polyester-modified silicone material, and the hydroxyl groups of the polyester resin are chemically bound to each other by dehydrocondensation. In this way, the film strength of the resulting bonding film 3 can be reliably improved.

In the bonding of the second base material 22 and the third base material 23 via the bonding film 3 in a later step 4, the ketone group of the polyester resin binds to the hydroxyl group of the base materials 22 and by hydrogen bonding at the interface between the bonding film 3 and the second base material 22, and between the bonding film 3 and the third base material 23. This enables the bonding film 3 to be strongly bonded to the bonding face 220 of the second base material 22, and to the bonding face 230 of the third base material 23.

2-2: Then, the liquid material 35 supplied onto the first base material 21, or specifically the liquid coating 30 selectively formed in the film forming region on the bonding face 210 is dried. As a result, the bonding film 3 is formed in patterns corresponding to the shape of the film forming region 41 (predetermined shape), as illustrated in FIG. 3C.

The drying temperature of the liquid coating 30 is preferably 25° C. or more, more preferably about 25 to 100° C.

The drying time is preferably about 0.5 to 48 hours, more preferably about 15 to 30 hours.

By drying the liquid coating 30 under these conditions, the bonding film 3 desirably developing adhesion can be reliably formed by imparting energy in the next steps 3 and 4. Further, when the silicone material includes a silanol group as described in step 2-1, or when a polyester-modified silicone material is used, the silanol groups of these materials can be reliably bonded to each other, and the film strength of the resulting bonding film 3 can be improved.

The pressure of the drying atmosphere may be atmospheric pressure, but is preferably reduced pressure. Specifically, the reduced pressure is preferably about 133.3×10⁻⁵ to 1,333 Pa (1×10⁻⁵ to 10 Torr), and more preferably about 133.3×10⁻⁴ to 133.3 Pa (1×10⁻⁴ to 1 Torr). This densifies the bonding film 3, and thus further improves the film strength of the bonding film 3.

As described above, by appropriately setting the conditions of forming the bonding film 3, the film strength or other properties of the resulting bonding film 3 can be altered as desired.

The average thickness of the bonding film 3 is preferably from about 10 to 10,000 nm, more preferably about 50 to 5,000 nm. By appropriately setting the supply amount of the liquid material 35 to confine the average thickness of the bonding film 3 in the foregoing ranges, there will be no significant decrease in the dimensional accuracy of the bonded structure of the second base material 22 and the third base material 23, and these materials can be bonded to each other even more strongly.

In other words, when the average thickness of the bonding film 3 is below the foregoing lower limit, sufficient bond strength may not be obtained. On the other hand, an average thickness of the bonding film 3 above the foregoing upper limit may lead to a significant decrease in the dimensional accuracy of the bonded structure.

Further, with the average thickness of the bonding film 3 falling in the foregoing ranges, the bonding film 3 becomes elastic to some extent. Thus, when bonding the second base material 22 and the third base material 23 in a later step 4, any particles or objects that may be present on the bonding face 230 of the third base material 23 brought into contact with the bonding film 3 can be entrapped by the bonding film 3 bonded to the bonding face 230. Thus, the bond strength between the bonding film 3 and the bonding face 230 will not be lowered by the presence of such particles, or detachment at the interface can be appropriately suppressed or prevented.

Step 3: Next, energy is imparted to the bonding film 3 to develop adhesion near the surface of the bonding film 3, and the first base material 21 is bonded to the second base material 22 via the bonding film 3, and then separated from the second base material 22 to transfer the bonding film 3 from the first base material 21 to the second base material 22 (third step).

The step is described below in detail.

3-1: First, energy is imparted to a surface 32 of the bonding film 3 formed in the film forming region 41 on the bonding face 210. The energy imparted to the bonding film 3 cuts some of the molecular bonds near the surface 32 of the bonding film 3, and thereby activates the surface 32. As a result, adhesion is developed near the surface 32 with respect to the second base material 22.

The bonding film 3 in this state is strongly bondable to the second base material 22 by chemical bonding.

As used herein, the “activated” state of the surface 32 refers to a state in which some of the molecular bonds on the surface 32 of the bonding film 3, specifically, for example, the methyl group of the polydimethylsiloxane backbone are cut to produce unterminated bonds (hereinafter, also referred to as “dangling bonds”) in the bonding film 3, or a state in which the dangling bond is terminated by the hydroxyl group (OH group). These states, including a coexisting state of these, are collectively referred to as the “activated” state of the bonding film 3.

Any method can be used to impart energy to the bonding film 3. Examples include irradiating the bonding film 3 with energy rays, heating the bonding film 3, applying a compression force (physical energy) to the bonding film 3, exposing the bonding film 3 to plasma (imparting plasma energy), and exposing the bonding film 3 to ozone gas (imparting chemical energy). In this way, the surface of the bonding film 3 can be efficiently activated.

Among these methods, it is particularly preferable to impart energy to the bonding film 3 by exposing the bonding film 3 to plasma, as illustrated in FIG. 3D.

Before explaining the reason the plasma exposure of the bonding film 3 is preferable as the method of imparting energy to the bonding film 3, problems associated with using an ultraviolet ray as the energy ray and irradiating the bonding film 3 with the ultraviolet ray are addressed.

A: Activation of the surface 32 of the bonding film 3 takes a long time (for example, 1 to several ten minutes). Further, when the duration of the ultraviolet ray irradiation is brief, the bonding of the second base material 22 and the third base material 23 takes a long time (at least several tens of minutes) in the bonding step. That is, it takes a long time to obtain the bonded structure 1.

B: When the ultraviolet ray is used, the ultraviolet ray has the likelihood of passing through the bonding film 3 in a direction of thickness. Thus, depending on the material (for example, resin material) of the base material (the first base material 21 in this embodiment), the interface (contacting face) between the base material and the bonding film 3 degrades, and the bonding film 3 easily detaches from the base material.

Further, the ultraviolet ray acts on the entire portion of the bonding film 3 as it passes through the bonding film 3 in a thickness direction, cutting and removing, for example, the methyl group of the polydimethylsiloxane backbone throughout the bonding film 3. Specifically, the amounts of organic components in the bonding film 3 become notably low, and the film becomes more inorganic. As a result, the flexibility of the bonding film 3 attributed to the presence of the organic components is reduced over all, and the resulting bonded structure 1 becomes susceptible to interlayer detachment in the bonding film 3.

C: When the bonded structure 1 is recycled or reused by detaching and separating the second base material 22 from the third base material 23, the base materials 22 and 23 are detached by imparting detachment energy to the bonded structure 1. Here, for example, the residual methyl group (organic component) in the bonding film 3 is cut and removed from the polydimethylsiloxane backbone, and the organic component so cut becomes a gas. The gas (gaseous organic component) then dissociates the bonding film 3 into pieces.

However, in the case of ultraviolet ray irradiation, because the bonding film 3 becomes more inorganic throughout in the manner described above, only a fraction of the organic component turns into a gas in response to the imparted detachment energy, and the bonding film 3 is hardly dissociated.

In contrast, in the plasma exposure of the surface 32 of the bonding film 3, some of the molecular bonds in the material forming the bonding film 3, for example, the methyl group of the polydimethylsiloxane backbone is selectively cut near the surface 32 of the bonding film 3.

Note that the plasma cutting of the molecular bond occurs in an extremely short time period because it is induced not only by the chemical action based on the plasma charge, but by the physical action based on the Penning effect of the plasma. Thus, the bonding film 3 can be activated in an extremely short time period (for example, on the order of several seconds), and as a result the bonded structure 1 can be produced in a short time.

The plasma selectively acts on the surface 32 of the bonding film 3, and hardly affects inside the bonding film 3. Thus, the cutting of the molecular bond selectively occurs near the surface 32 of the bonding film 3. In other words, the bonding film 3 is selectively activated near the surface 32. Accordingly, the problems associated with the activation of the bonding film 3 by the ultraviolet ray (problems B and C above) are unlikely to occur.

In this manner, by using plasma for the activation of the bonding film 3, interlayer detachment of the bonding film 3 in the bonded structure 1 hardly occurs, and the second base material 22 can be reliably detached from the third base material 23 when such a procedure is desired.

In the ultraviolet ray activation of the bonding film 3, the extent to which the bonding film 3 is activated is highly dependent on the intensity of the ultraviolet ray irradiation. Thus, the ultraviolet ray irradiation needs to be performed under strictly controlled conditions, in order to activate the bonding film 3 to such an extent suitable for the bonding of the second base material 22 and the third base material 23. Without such strict control, there will be variation in the bond strength between the second base material 22 and the third base material 23 in the resulting bonded structure 1.

In contrast, in the plasma activation of the bonding film 3, the activation of the bonding film 3 proceeds more gradually in a manner that depends on the density of the contacted plasma. Accordingly, the conditions of plasma generation do not require strict control for the activation of the bonding film 3 to an extent suitable for the bonding of the second base material 22 and the third base material 23. In other words, the plasma activation of the bonding film 3 is more tolerant in terms of manufacturing conditions of the bonded structure 1. Further, variation in the bond strength between the second base material 22 and third base material 23 in the bonded structure 1 hardly occurs even without any strict control.

The ultraviolet ray activation of the bonding film 3 is also problematic in that the bonding film 3 itself shrinks (especially, in thickness) as a result of activation, or specifically as a result of the elimination of the organics in the bonding film 3. When the bonding film 3 shrinks, high-strength bonding of the second base material 22 and the third base material 23 becomes difficult.

In contrast, the bonding film 3 rarely shrinks, if any, with the plasma activation of the bonding film 3 that selectively activates near the surface of the bonding film 3 in the manner described above. Thus, the second base material 22 and the third base material 23 can be bonded to each other with high bond strength even when the bonding film 3 is relatively thin. Further, in this case, the bonded structure 1 can have high dimensional accuracy, and the thickness of the bonded structure 1 can be reduced.

As described above, the plasma activation of the bonding film 3 has many advantages over the ultraviolet ray activation of the bonding film 3.

The plasma may be contacted with the bonding film 3 under reduced pressure, or preferably under atmospheric pressure. Specifically, it is preferable that the bonding film 3 be treated with an atmospheric pressure plasma. In the atmospheric pressure plasma treatment, because the surroundings of the bonding film 3 is not reduced pressure, for example, the methyl group of the polydimethylsiloxane backbone of the polyester-modified silicone material will not be unnecessarily cut when cutting and removing the methyl group (during the activation of the bonding film 3) by the action of plasma.

The plasma treatment under atmospheric pressure can be performed using, for example, the atmospheric pressure plasma treatment apparatus illustrated in FIG. 6.

FIG. 6 is a schematic diagram showing a structure of the atmospheric pressure plasma apparatus.

An atmospheric pressure plasma apparatus 1000 illustrated in FIG. 6 includes a carrier unit 1002 provided for the transport of the first base material 21 on which the bonding film 3 has been formed (hereinafter, simply referred to as “worked substrate W”), and a head 1010 disposed above the carrier unit 1002.

The atmospheric pressure plasma apparatus 1000 includes a plasma generating region p, where a plasma is generated, formed between an apply electrode 1015 and a counter electrode 1019 of the head 1010.

The structure of each component is described below.

The carrier unit 1002 includes a movable stage 1020 that can carry the worked substrate W. The movable stage 1020 is made movable along the direction of x axis by the activation of a moving section (not shown) provided for the carrier unit 1002.

The movable stage 1020 is made of metal materials, for example, such as stainless steel and aluminum.

The head 1010 includes a head main body 1101, in addition to the apply electrode 1015 and the counter electrode 1019.

In the head 1010, a gas supply channel 1018 is provided through which a processing plasma gas G is supplied to a gap 1102 between an upper surface of the movable stage 1020 (carrier unit 1002) and a lower face 1103 of the head 1010.

The gas supply channel 1018 has an opening 1181 formed at the lower face 1103 of the head 1010. As illustrated in FIG. 6, there is a step difference on the left of the lower face 1103. Accordingly, a gap 1104 between the left-hand side of the head main body 1101 and the movable stage 1020 is smaller (narrower) than the gap 1102. This suppresses or prevents the processing plasma gas G from entering the gap 1104, producing a preferential flow of the processing plasma gas G in the positive direction along the x axis.

The head main body 1101 is made of dielectric materials, for example, such as alumina and quartz.

In the head main body 1101, the apply electrode 1015 and the counter electrode 1019 are disposed face to face with the gas supply channel 1018 in between, so as to form a pair of parallel-plate electrodes. The apply electrode 1015 is electrically connected to a high-frequency power supply 1017. The counter electrode 1019 is grounded.

The apply electrode 1015 and the counter electrode 1019 are made of metal materials, for example, such as stainless steel and aluminum.

In the plasma treatment of the worked substrate W with the atmospheric pressure plasma apparatus 1000, voltage is applied between the apply electrode 1015 and the counter electrode 1019 to generate an electric field E. In this state, the processing gas G is dispersed into the gas supply channel 1018. The processing gas G dispersed into the gas supply channel 1018 discharges under the influence of the electric field E, and a plasma gas is produced. The resulting processing plasma gas G is then supplied into the gap 1102 through the opening 1181 on the lower face 1103. As a result, the processing plasma gas G contacts the surface 32 of the bonding film 3 formed on the worked substrate W, thus completing the plasma treatment.

With the atmospheric pressure plasma apparatus 1000, the plasma is able to contact the bonding film 3 both easily and reliably, enabling activation of the bonding film 3.

Here, the distance between the apply electrode 1015 and the movable stage 1020 (worked substrate W), or specifically the height of the gap 1102 (length h1 in FIG. 6) is appropriately selected taking into account such factors as the output of the high-frequency power supply 1017, and the type of plasma treatment performed on the worked substrate W. Preferably, the distance is about 0.5 to 10 mm, more preferably about 0.5 to 2 mm. In this way, the activation of the bonding film 3 by the plasma contact can be performed even more reliably.

The voltage applied between the apply electrode 1015 and the counter electrode 1019 is preferably from about 1.0 to 3.0 kVp-p, more preferably from about 1.0 to 1.5 kVp-p. This further ensures the generation of electric field E between the apply electrode 1015 and the movable stage 1020, and the processing gas G supplied into the gas supply channel 1018 can be reliably turned into a plasma gas.

The frequency of the high-frequency power supply 1017 (the frequency of applied voltage) is not particularly limited, and is preferably about 10 to 50 MHz, more preferably about 10 to 40 MHz.

The type of processing gas G is not particularly limited, and rare gases such as helium gas and argon gas, and oxygen gas can be used, for example. These may be used in combinations of one or more. Gases containing a rare gas as the primary component are preferably used as the processing gas G, and gases containing helium gas as the primary component are particularly preferable.

More specifically, the plasma used for the treatment is preferably produced from a gas that contains helium gas as the primary component. The gas containing helium gas as the primary component (processing gas G) does not easily generate ozone when turned into a plasma gas, and thus the ozone alteration (oxidation) on the surface 32 of the bonding film 3 can be prevented. This suppresses the reduction in the extent of bonding film 3 activation; in other words, the bonding film 3 can be reliably activated. Further, the helium gas-based plasma has an extremely high Penning effect, and is therefore also preferable in terms of reliably activating the bonding film 3 in a short time period.

In this case, the supply rate of the gas that contains helium gas as the primary component to the gas supply channel 1018 is preferably from about 1 to 20 SLM, more preferably from about 5 to 15 SLM. This makes it easier to control the extent of bonding film 3 activation.

The helium gas content of the gas (processing gas G) is preferably 85 vol % or more, more preferably 90 vol % or more (including 100%). In this way, the foregoing effects can be exhibited even more effectively.

The mobility rate of the movable stage 1020 is not particularly limited, and is preferably about 1 to 20 mm/second, more preferably about 3 to 6 mm/second. By allowing the plasma to contact the bonding film 3 at such a rate, the bonding film 3 can be sufficiently and reliably activated despite the short contact time.

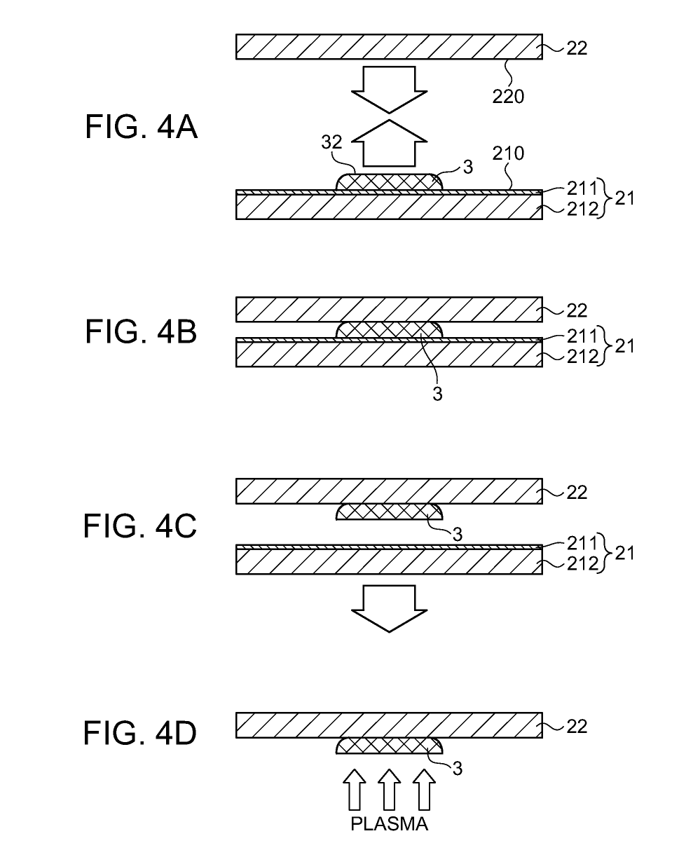

3-2: Next, as illustrated in FIG. 4A, the first base material 21 and the second base material 22 are bonded to each other via the bonding film 3, with the bonding film 3 closely in contact with the second base material 22. Here, because the surface 32 of the bonding film 3 has developed adhesion for the second base material in step 3-1, the bonding film 3 and the bonding face 220 of the second base material 22 are chemically bonded to each other, as illustrated in FIG. 4B.

The mechanism by which the bonding film 3 and the second base material 22 are bonded to each other in this step is described below.

Taking as an example the second base material 22 exposing the hydroxyl group on the bonding face 220, mating the first base material 21 and the second base material 22 with the bonding film 3 of the first base material 21 in contact with the bonding face 220 of the second base material 22 in this step produces hydrogen-bond attraction between the hydroxyl group on the surface of the bonding film 3 and the hydroxyl group on the bonding face 220 of the second base material 22, thus generating an attraction force between the hydroxyl groups. Presumably, the first base material 21 and the second base material 22 are bonded to each other by this attraction force.

The hydroxyl groups attracted to each other by hydrogen bonding are cut from the surfaces by accompanying dehydrocondensation, depending on temperature or other conditions. As a result, the atoms originally attached to the hydroxyl groups form bonds at the contact interface between the bonding film 3 and the second base material 22. This is believed to be the basis of the strong bonding between the bonding film 3 and the second base material 22.

When unterminated bonds, or specifically dangling bonds exist on the surface or inside the bonding film 3 of the first base material 21, and on the bonding face 220 or inside the second base material 22, these dangling bonds rejoin when the first base material 21 and the second base material 22 are mated together. The rejoining of the dangling bonds occurs in a complicated manner that involves overlap or tangling, and thus a network of bonds is formed on the bonded interface. As a result, the bonding film 3 and the second base material 22 are strongly bonded to each other particularly.

The activated state of the surface of the bonding film 3 activated in step 3-1 attenuates over time. It is therefore preferable that step 3-2 be performed as soon as step 3-1 is finished. Specifically, it is preferable to perform step 3-2 within 60 minutes after step 3-1, more preferably within 5 minutes after step 3-1. With these time ranges, the activated state of the bonding film 3 surface is sufficiently maintained, and sufficient bond strength can be obtained between the bonding film 3 and the second base material 22 when the first base material 21 and the second base material 22 are mated to each other.

In other words, because the bonding film 3 before activation is a bonding film obtained by drying the silicone material, the bonding film 3 is relatively chemically stable, and excels in weather resistance. Thus, the bonding film 3 before activation is well suited for long storage. By taking advantage of this, the first base material 21 including such a bonding film 3 may be produced or purchased in a large quantity and stored for later use, and energy may be imparted as in step 3-1 only in a desired quantity. This is effective in terms of efficient manufacture of the bonded structure 1.

3-3: Next, the first base material 21 and the second base material 22 are separated from each other.

Because the bonding film 3 is formed on the liquid repellent film 211 of the first base material 21, the bond strength for the first base material 21 is extremely weak. In contrast, because the bonding film 3 is chemically bonded to the bonding face 220 of the second base material 22, the bond strength for the second base material 22 is much higher than that between the bonding film 3 and the first base material 21.

Thus, detaching the first base material 21 from the second base material 22 detaches the bonding film 3 from the bonding face 210 of the first base material 21, thus transferring the bonding film 3 from the first base material 21 to the second base material 22, as illustrated in FIG. 4C.

Step 4: Next, after the transfer, energy is imparted to the bonding film 3 to develop adhesion near the other surface of the bonding film 3, and the second base material 22 and the third base material 23 are bonded to each other via the bonding film 3 to obtain the bonded structure 1 of the second base material 22 and the third base material 23 (fourth step).

This step is described below in detail.

4-1: First, energy is imparted to the bonding film 3 transferred from the first base material 21 to the second base material 22.

Because the bonding film 3 is transferred from the first base material 21 to the second base material 22, the surface originally bonded to the first base material 21 is exposed on the second base material 22.

The energy imparted to the bonding film 3 cuts some of the molecular bonds near the surface, and thereby activates the surface. As a result, adhesion is developed. Thus, in this step, the surface bonded to another base material (the first base material 21 in this embodiment) can also develop adhesion by imparting energy again.

Any method can be used to impart energy to the bonding film 3. However, it is particularly preferable, as in step 3-1, to expose the bonding film 3 to plasma, as illustrated in FIG. 4D.

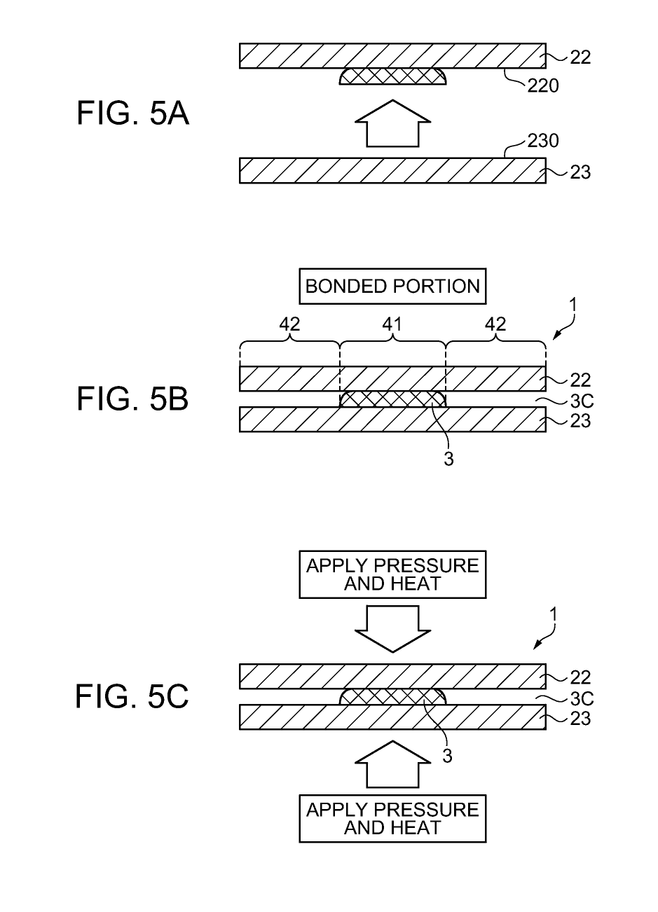

4-2: Next, the second base material 22 and the third base material 23 are bonded to each other with the bonding film 3 formed on the second bonding material 22 closely in contact with the third base material 23 (see FIG. 5A). Because the surface of the bonding film 3 has developed adhesion for the third base material 23 in the foregoing step 4-1, the bonding film 3 and the bonding face 230 of the third base material 23 are chemically bonded to each other. As a result, the second base material 22 and the third base material 23 are partially bonded together via the bonding film 3 selectively formed in the film forming region 41, and the bonded structure 1 as illustrated in FIG. 5B is obtained.

In this step, the bonding film 3 and the third base material 23 are bonded by the same mechanism by which the bonding film 3 and the second base material 22 are bonded in step 3-2.

As described above, a bonding method according to an embodiment produces the bonded structure 1 by first forming the bonding film 3 in advance on the first base material 21 that includes the liquid repellent film 211, and then bonding the second base material 22 and the third base material 23 to each other via the bonding film 3 after transferring the bonding film 3 from the first base material 21 to the second base material 22. In this way, the spread of the liquid material 35 on the first base material 21 can be appropriately suppressed or prevented, and the bonding film 3 can be formed in patterns corresponding to the shape of the film forming region 41 even when the film forming region 41 has microscopic dimensions. The bonding film 3 can then be transferred from the first base material 21 to the second base material 22, ensuring that the bonded structure 1 is obtained from the second base material 22 and the third base material 23 bonded to each other via the bonding film 3.

In the bonded structure 1 of the foregoing configuration, the adhesion providing the bonding between the base materials 22 and 23 is not based on physical bonding by the anchor effect as in the adhesive used in the existing bonding methods, but rather is based on strong chemical bonds, such as covalent bonds, that are formed in a short time period. Thus, the bonded structure 1 can be formed in a short time period, and is extremely resistant to detaching, and rarely involves uneven bonding or other defects.

Because the bonding method does not require a high-temperature heat treatment (for example, 700° C. or more), the second base material 22 and the third base material 23 can be bonded even when these materials are made of low heat resistant materials.

Further, because the second base material 22 and the third base material 23 are bonded to each other via the bonding film 3, there is no restriction to the materials of the base materials 22 and 23.

Thus, this technique provides a wide range of selection for the materials of the second base material 22 and the third base material 23.

When the second base material 22 and the third base material 23 have different coefficients of thermal expansion, the bonding temperature should be kept as low as possible. By bonding under low temperatures, the thermal stress that generates at the bonded interface can be further reduced.

Specifically, the second base material 22 and the third base material 23 are bonded to each other at the material temperature of about 25 to 50° C., more preferably about 25 to 40° C., though it depends on the difference in the coefficient of thermal expansion between the second base material 22 and the third base material 23. With these temperature ranges, the thermal stress generated at the bonded interface can be sufficiently reduced even when there is some large difference in the coefficient of thermal expansion between the second base material 22 and the third base material 23. As a result, defects such as warping and detachment can be reliably suppressed or prevented in the bonded structure 1.

Specifically, in this case, when the difference in the thermal expansion coefficients of the second base material 22 and the third base material 23 is 5×10⁻⁵/K or more, it is particularly recommended that bonding be performed at as low a temperature as possible.

Further, in the present embodiment, the bonding between the second base material 22 and the third base material 23 is made on the film forming region 41 where the bonding film 3 is selectively formed, instead of over the entire opposing surfaces of these base materials. Here, the bonding region can easily be selected simply by appropriately adjusting the size of the film forming region 41 forming the bonding film 3. In this way, the bond strength of the bonded structure 1 can be easily adjusted by controlling, for example, the area or shape of the bonding film 3 used to bond the second base material 22 and the third base material 23 together. As a result, the bonded structure 1 can be obtained in which, for example, the bonding films 3 can be easily detached.

Specifically, the force (splitting strength) needed to separate the bonded structure 1 can be adjusted while adjusting the bond strength of the bonded structure 1.

From this viewpoint, when producing a bonded structure 1 that is easily separable, it is preferable that the bonded structure 1 have such a bond strength that separation is readily possible with human hands. In this way, the bonded structure 1 can easily be separated without using machines or other means.

Further, localized stress concentration at the bonding film 3 can be relieved by appropriately setting the area or shape of the bonding film 3 used to bond the second base material 22 and the third base material 23. In this way, the base materials 22 and 23 can be reliably bonded to each other even when, for example, there is a large difference in the coefficient of thermal expansion between the second base material 22 and the third base material 23.

Further, according to the bonding method of the present embodiment, a space 3C with the distance (height) corresponding to the thickness of the bonding films 3 is formed between the second base material 22 and the third base material 23 in the film devoid region 42, as illustrated in FIG. 5C. By taking advantage of the space 3C, a closed space or a channel can be formed between the second base material 22 and the third base material 23 by appropriately adjusting the shape of the film forming region 41.

The bonded structure (a bonded structure of an embodiment of the invention) 1 illustrated in FIG. 5B can be obtained in the manner described above.

In the bonded structure 1 obtained as above, the bond strength between the second base material 22 and the third base material 23 is preferably 4 MPa (40 kgf/cm²) or more, more preferably 10 MPa (100 kgf/cm²) or more. The bonded structure 1 having such a bond strength can sufficiently prevent detachment. Further, with a bonding method according to an embodiment of the invention, the bonded structure 1 can be efficiently produced in which the second base material 22 and the third base material 23 are bonded to each other with a large bond strength.

Note that when obtaining the bonded structure 1 or after the bonded structure 1 is obtained, the bonded structure 1 may be subjected to at least one of the two steps (5A and 5B; the steps of increasing the bond strength of the bonded structure 1) below, as desired. In this way, the bond strength of the bonded structure 1 can be further improved with ease.

Step 5A: The bonded structure 1 is pressed to bring the second base material 22 and the third base material 23 towards each other.

In this way, the surfaces of the bonding film 3 closely contact the surface of the second base material 22 and the surface of the third base material 23, and the bond strength of the bonded structure 1 can be further improved.

Further, by pressing the bonded structure 1, any gap that may be present at the bonded interface in the bonded structure 1 can be flattened to further increase the bonding area. This further improves the bond strength of the bonded structure 1.

Note that the pressure may be appropriately adjusted according to conditions such as the material and thickness of the second base material 22 and the third base material 23, and the bonding apparatus. Specifically, the pressure is preferably about 0.2 to 100 MPa, more preferably about 1 to 50 MPa, though it is slightly variable depending on factors such as the material and thickness of the second base material 22 and the third base material 23. In this way, the bond strength of the bonded structure 1 can be reliably improved. The pressure may exceed the foregoing upper limit; however, in this case, damage or other defects may occur in the second base material 22 and the third base material 23 depending on the material of the base materials 22 and 23.

The pressure time is not particularly limited, and is preferably about 10 seconds to 30 minutes. The pressure time may be appropriately varied according to the applied pressure. Specifically, the pressure time can be made shorter with increase in applied pressure on the bonded structure 1. The bond strength also can be improved in this case.

Step 5B: The bonded structure 1 is heated.

This further improves the bond strength of the bonded structure 1.

Here, the heating temperature of the bonded structure 1 is not particularly limited as long as it is higher than room temperature and below the heat resistant temperature of the bonded structure 1. Preferably, the heating temperature is about 25 to 100° C., more preferably about 50 to 100° C. With the heating temperature in these ranges, the heat alteration or degradation of the bonded structure 1 can be reliably prevented, and the bond strength can be reliably improved.

The heating time is not particularly limited, and is preferably about 1 to 30 minutes.

When performing both steps 5A and 5B, it is preferable that these steps be performed simultaneously. Specifically, as illustrated in FIG. 5C, it is preferable to heat the bonded structure 1 while simultaneously applying pressure. This provides synergy from the pressure and heat application, and the bond strength of the bonded structure 1 can be particularly improved.

### Second Embodiment

A Second Embodiment of a bonding method is described below.

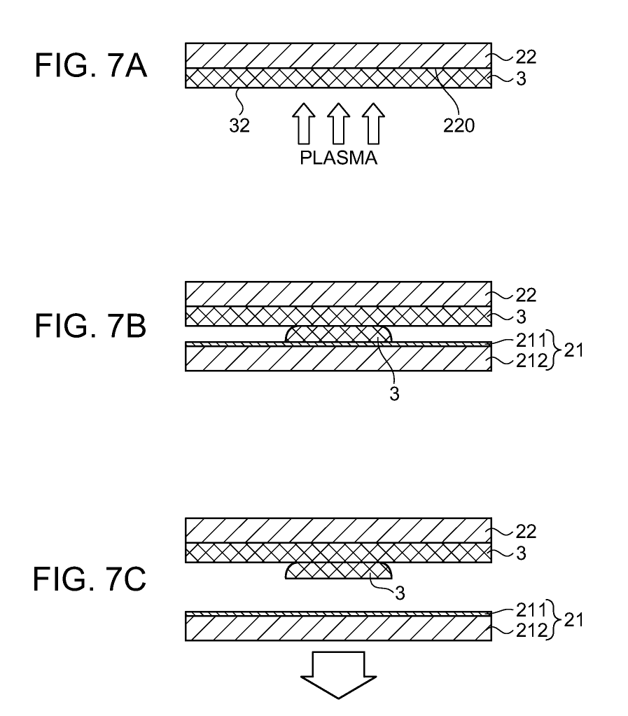

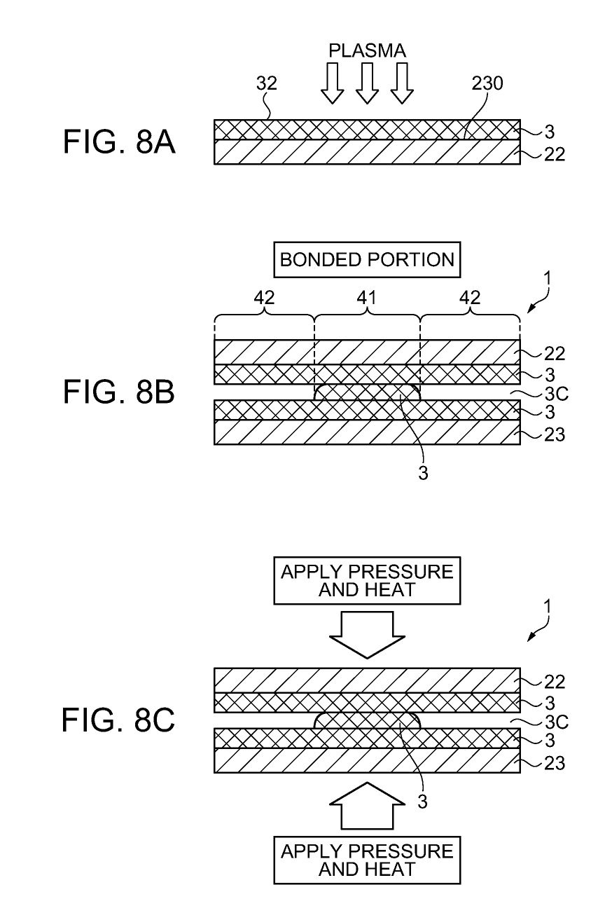

FIGS. 7A to 7C and FIGS. 8A to 8C are diagrams (longitudinal sections) explaining a Second Embodiment of a bonding method. In the descriptions below, the upper and lower sides of FIGS. 7A to 7C and FIGS. 8A to 8C will be referred to as “upper” and “lower”, respectively.

The description of the Second Embodiment will be given with a primary focus on differences from the bonding method of the First Embodiment, and matters already described will not be described again.

In a bonding method according to the present embodiment, the bonding film 3 is also formed over substantially the entire areas of the bonding faces 220 and 230 of the second and third base materials 22 and 23, in addition to being formed in the film forming region 41 on the bonding face (surface) 210 of the first base material 21. The present embodiment does not differ from the foregoing First Embodiment except that adhesion is developed near the surfaces of the bonding films 3 on the second and third base materials 22 and 23, and that the bonded structure 1 is obtained by bonding the second base material 22 and the third base material 23 to each other on their bonding films 3 via the bonding film 3 transferred from the first base material 21.

Step 1′: The first base material 21, the second base material 22, and the third base material 23 are prepared as in step 1.

Step 2′: Then, the bonding film 3 patterned into a predetermined shape is formed in the film forming region 41 on the bonding face 210 of the first base material 21 as in step 2. The bonding film 3 is also formed over substantially the entire areas of the bonding faces 220 and 230 of the second and third base materials 22 and 23.

Step 3′: Next, as illustrated in FIG. 7A, energy is imparted to the bonding film 3 formed on the bonding face 220 of the second base material 22 to develop adhesion near the surface of the bonding film 3 formed on the second base material 22.

Then, as illustrated in FIG. 7B, the first base material 21 and the second base material 22 are bonded to each other via their respective bonding films 3, and then separated from each other to transfer the bonding film 3 of the first base material 21 to the second base material 22 (see FIG. 7C)

Providing the bonding film 3 on both the first base material 21 and the second base material 22 as in the present embodiment strengthens the bonding made by the bonding film 3, and thus enables the bonding film 3 of the first base material 21 to be more reliably detached from the first base material 21.

Energy can be imparted to the bonding film 3 of the second base material 22 by the same method used in step 3. The plasma exposure of the bonding film 3 is particularly preferable.

Further, energy may be imparted not only to the bonding film 3 of the second base material 22 but also to the bonding film 3 of the first base material 21. Furthermore, instead of imparting energy to the bonding film 3 of the second base material 22, energy may be imparted only to the bonding film 3 of the first base material 21.

Step 4′: Next, as illustrated in FIG. 8A, energy is imparted to the bonding film 3 formed on the bonding face 230 of the third base material 23 to develop adhesion near the surface of the bonding film 3 formed on the third base material 23.

Then, as illustrated in FIG. 8B, the second base material 22 and the third base material 23 are bonded to each other via their respective bonding films 3 to obtain the bonded structure 1 in which the second base material 22 and the third base material 23 are bonded together.

Providing the bonding film 3 both on the second base material 22 and the third base material 23 as in the present embodiment strengthens the bonding made by the bonding film 3, and thus further improves the bond strength of the bonded structure 1.

Energy may be imparted not only to the bonding film 3 of the third base material 23 but also to the bonding film 3 of the second base material 22. Furthermore, instead of imparting energy to the bonding film 3 of the third base material 23, energy may be imparted only to the bonding film 3 of the second base material 22.

Thus, the bonded structure 1 can alternately be obtained in this manner.

After the bonded structure 1 is obtained, the bonded structure 1 may be subjected to at least one of the steps 5A and 5B of the First Embodiment, as desired.

For example, as illustrated in FIG. 8C, the bonded structure 1 is heated while simultaneously applying pressure so as to bring the base materials 22 and 23 of the bonded structure 1 closer together. This promotes the dehydrocondensation of the hydroxyl groups and rejoining of the dangling bonds at the interface between the bonding films 3. As a result, the bonding films 3 are further integrated and finally become almost completely one piece.

The present embodiment has been described through the case where the bonding film 3 is formed over substantially the entire areas of the bonding faces (surfaces) 220 and 230 of the second and third base materials 22 and 23. However, the invention is not limited to this, and the bonding film 3 may be formed on one of the bonding faces (surfaces) 220 and 230.

### Organic Emitting Device

The following embodiment describes an organic emitting device using a bonded structure of an embodiment of the invention.

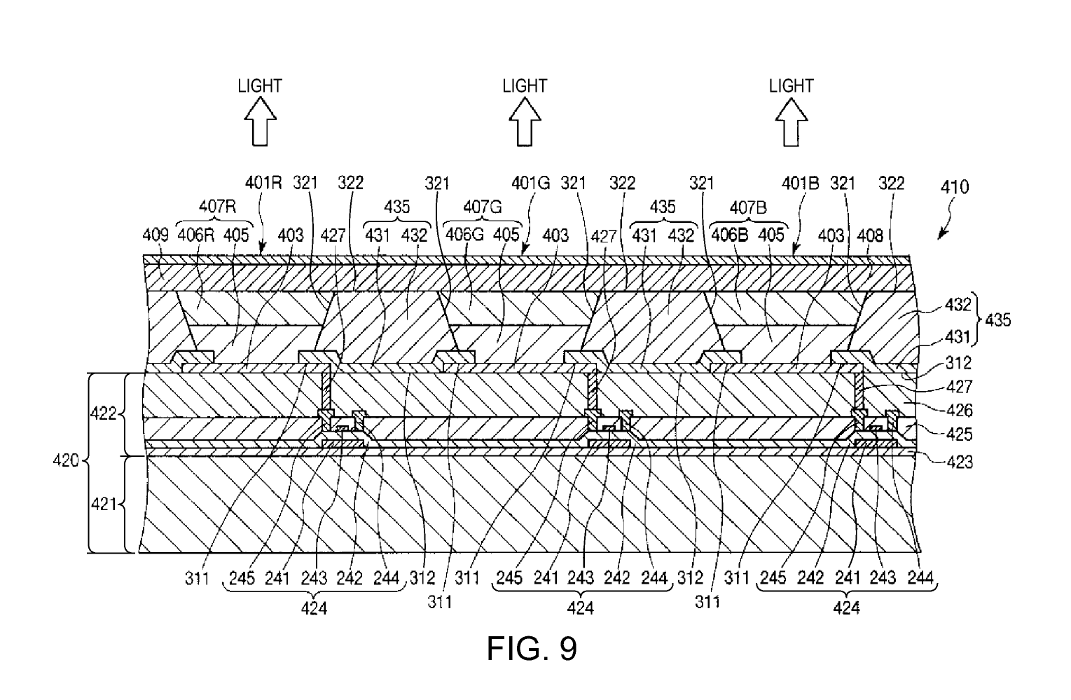

FIG. 9 is a longitudinal sectional view representing an embodiment of an active-matrix organic emitting device using a bonded structure of an embodiment of the invention.

In the descriptions below, the upper and lower sides of FIG. 9 will be referred to as “upper” and “lower”, respectively.

An organic emitting device 410 illustrated in FIG. 9 includes: a plate-like TFT circuit board (substrate) 420; organic EL elements 401R, 401G, and 401B provided on the TFT circuit board 420, and that emit the colors of red (R), green (G), and blue (B), respectively; barrier rib portions 435 provided to compartmentalize the organic EL elements 401R, 401G, and 401B; and an upper substrate (protective substrate) 409 facing the TFT circuit board 420.

In the following, the organic EL elements 401R, 401G, and 401B are also collectively referred to as organic EL elements 401. Likewise, organic semiconductor layers (multilayered organic semiconductor layers) 407R, 407G, and 407B respectively forming the organic EL elements 401R, 401G, and 401B are also collectively referred to as organic semiconductor layers 407. Further, emissive layers 406R, 406G, and 406B respectively forming the organic semiconductor layers 407R, 407G, and 407B are also collectively referred to as emissive layers 406.

A substrate 421 serves as a support for each member of the organic emitting device 410. The upper substrate 409 serves as, for example, a protective film for the organic EL elements (organic emitting elements) 401R, 401G, and 401B by being disposed on these elements.

Because the organic emitting device 410 of the present embodiment is configured to draw light from the upper substrate 409 side (on the side of a cathode (second electrode) 408; described later) (top emission), the upper substrate 409 is essentially transparent (colorless transparent, colored transparent, semitransparent), whereas no transparency is particularly required for the substrate 421.

Various glass substrates and resin substrates with relatively high hardness are preferably used for the substrate 421.

For the upper substrate 409, various types of transparent glass substrates and transparent resin substrates are selected. For example, such transparent substrates may be primarily made of glass materials such as fused quartz and soda glass, or resin materials such as polyethylene terephthalate and polyethylene naphthalate. With these materials, the upper substrate 409 shows excellent optical transparency, ensuring that the light emerges from the upper substrate 409 (see FIG. 9).

A circuit section 422 includes a base protective layer 423 formed on the substrate 421, driving TFTs (switching elements) 424 formed on the base protective layer 423, a first interlayer insulating layer 425, and a second interlayer insulating layer 426.

The driving TFTs 424 include a semiconductor layer 241, a gate insulating layer 242 formed on the semiconductor layer 241, and a gate electrode 243, a source electrode 244, and a drain electrode 245 formed on the gate insulating layer 242.

The organic EL elements 401R, 401G, and 401B are provided on the circuit section 422, respectively corresponding to the driving TFTs 424.

Further, as illustrated in FIG. 9, the adjacent organic EL elements 401R, 401G, and 401B are compartmentalized by the barrier rib portions (bank) 435. The barrier rib portions 435 are provided between a pair of opposing anode 403 and cathode 408, and also serve to regulate the distance between these electrodes.

Each barrier rib portion 435 is structured to include a plate-like first barrier rib portion 431, and a block-shaped second barrier rib portion 432 formed on the first barrier rib portion 431. The first barrier rib portion 431 is provided between adjacent anodes 403. Further, the first barrier rib portion 431 includes an anode bonded portion 311 in contact with (bonded to) the anode 403, and a substrate bonded portion 312 in contact with (bonded to) the upper surface of the circuit section 422 of the TFT circuit board 420. In this way, the barrier rib portions 435 are securely fixed onto the TFT circuit board 420. The second barrier rib portion 432 is provided with the primary purpose to surround the organic semiconductor layers 407. The second barrier rib portion 432 has slanted side faces 321 that merge towards each other in the direction upward. An upper surface (top surface) 322 of the second barrier rib portion 432 is flat.

The barrier rib portions 435 configured as above form a grid as a whole in a plan view. Accordingly, the organic semiconductor layers 407 (organic EL elements 401) are provided on the inner side of the barrier rib portions 435, and thus the organic semiconductor layers 407 are in the form of a matrix. The organic EL elements 401 are therefore suitable for the organic emitting device 410. Further, because the barrier rib portions 435 form a grid, the barrier rib portions 435 can be bonded to the cathode 408 at a relatively large number of locations. This improves the bond strength for the cathode 408, and thus ensures an extended life for the organic emitting device 410.

The materials of the first barrier rib portions 431 and the second barrier rib portions 432 are selected taking into consideration factors such as heat resistance, liquid repellency, ink solvent resistance, and adhesion to the underlying layer.

Specifically, the first barrier rib portion 431 and the second barrier rib portion 432 may be made of materials, for example, including silicon oxide (inorganic materials) such as SiO₂, and resin materials (organic materials) such as acryl-based resin, and polyimide-based resin. The materials of the first barrier rib portion 431 and the second barrier rib portion 432 may be the same or different.

The height of the barrier rib portions 435 is preferably, for example, about 30 to 500 nm, though it depends on the total thickness of the anode 403, hole transport layer 405, and emissive layer 406. In such a height range, the barrier rib portions 435 can sufficiently exhibit the function of the barrier ribs (bank).

In the present embodiment, the anode 403 for the organic EL elements 401R, 401G, and 401B is provided as an individual electrode (pixel electrode), and is electrically connected to the drain electrode 245 of each driving TFT 424 via a wire 427. Further, the anode 403 is provided for each of the organic semiconductor layers 407R, 407G, and 407B that include the hole transport layer 405 and the emissive layers 406R, 406G, 406B, respectively, and thus is individually formed for the organic EL elements 401R, 401G, and 401B. The cathode 408 is provided as a common electrode.

The organic EL elements 401R, 401G, and 401B are disposed in a matrix in a plan view, and form a single pixel in a set of three.

In the organic emitting device 410, the organic EL elements 401R, 401G, and 401B are configured from the individual (multiple) anodes 403, the cathode 408 covering the anodes 403 in a plan view, and the organic semiconductor layers 407R, 407G, and 407B provided between their respective anodes 403 and the cathode 408. In the present embodiment, the organic semiconductor layers 407R, 407G, and 407B have a multilayer structure in which the hole transport layer 405 and each emissive layer 406R, 406G, or 406B is stacked in this order from the anode 403 side.

Further, by providing the cathode 408 to cover the anodes 403, the cathode 408 serves as a common electrode for all the anodes 403. Because the cathode 408 is not provided individually, the structure of the organic emitting device 410 can be simplified.

The anodes 403 are provided (stacked) on the upper surface (one of the surfaces) of the circuit section 422 of the TFT circuit board 420, and serve to inject holes into the hole transport layers 405 (organic semiconductor layers 407).

The material of the anode 403 is not particularly limited as long as it is conductive. Preferably, materials having a large work function and good conductivity are used.

Examples of such anode materials include ITO (indium oxide and zinc oxide composite), oxides such as SnO₂, Sb-containing SnO₂, and Al-containing ZnO, elements such as Al, Ni, Co, Au, Pt, Ag, and Cu, and alloys thereof. At least one of these materials can be used.

The average thickness of the anode 403 is not particularly limited, and is preferably about 10 to 200 nm, more preferably about 50 to 150 nm. When the anode 403 is too thin, the anode 403 may fail to sufficiently exhibit its function. When too thick, the recombination of the holes and electrons (described later) may fail to occur in the emissive layers 406, with the result that emission efficiency or other characteristics of the organic EL element 401 is impaired.

Note that conductive resin materials, for example, such as polythiophene and polypyrrole can be used as anode materials.

The cathode 408 is the electrode provided to inject electrons into the organic semiconductor layer 407 (emissive layer 406).

For the material of the cathode 408, transparent conductive materials with translucency are selected, because the organic emitting device 410 is a top-emitting device in which light is drawn from the cathode 408 side.

Examples of such cathode materials include transparent conductive materials such as indium tin oxide (ITO), fluorine-containing indium tin oxide (FITO), antimony tin oxide (ATO), indium zinc oxide (IZO), aluminum zinc oxide (AZO), tin oxide (SnO₂), zinc oxide (ZnO), fluorine-containing tin oxide (FTO), fluorine-containing indium oxide (FIO), and indium oxide (IO). These may be used in combinations of one or more.

The average thickness of the cathode 408 is not particularly limited, and is preferably about 100 to 3,000 nm, more preferably about 500 to 2,000 nm. When the cathode 408 is too thin, the cathode 408 may fail to sufficiently exhibit its function. When too thick, transmittance may decrease depending on the type or properties of the cathode material, making the organic EL element 401 unsuitable for practical use as a top-emitting device.

In the organic emitting device 410 of the configuration above, a bonded structure of an embodiment of the invention is used as the bonded structure of the second barrier rib portion 432 and the cathode 408.

Specifically, a bonding method of an embodiment of the invention is used for the bonding of the upper surface 322 of the second barrier rib portion 432 and the lower face of the cathode 408. In this case, the bonding film 3 corresponding to the shape of the upper surface 322 of the second barrier rib portion 432 is transferred onto the cathode 408 from another substrate having liquid repellency, and the upper surface 322 of the second barrier rib portion 432 is bonded to the lower face of the cathode 408 via the bonding film 3 to obtain the bonded structure of the second barrier rib portion 432 and the cathode 408.

A description has been made with respect to certain embodiments of bonding methods and bonded structures with reference to the attached drawings. It should be noted however that the invention is not limited to the foregoing descriptions.

For example, in a bonding method of the invention, one or more steps may be added for any purpose, as desired.

Further, a bonded structure of the invention is to be construed as also being applicable to fields other than organic emitting devices. Specifically, a bonded structure of the invention is applicable to, for example, droplet discharge heads and crystal devices.

### Examples

The following describes specific examples of the invention.

### Example 1

First, the first base material was prepared by forming a polytetrafluoroethylene (PTFE) film on a surface of a monocrystalline silicon substrate (length 20 mm×width 20 mm×average thickness 1 mm). The second base material and the third base material were prepared from glass substrates (length 20 mm×width 20 mm×average thickness 1 mm), and these glass substrates were subjected to a surface treatment using oxygen plasma.

Next, a silicone material was prepared using a liquid material that contains a polyester-modified silicone material (Momentive Performance Materials Inc., Japan; XR32-A1612). The liquid material was then supplied onto the first base material in the form of 5-pL droplets using an inkjet method, so as to form a liquid coating in the shape of the letter E with the width of each line measuring about 60 μm.

The liquid coating was then dried and cured by heating it at 200° C. for 1 hour, so as to form a bonding film (average thickness: about 100 nm; width of each line: 60 μm) on the first base material.

Then, a plasma was brought into contact with the bonding film formed on the first base material under the conditions below, using the atmospheric pressure plasma apparatus illustrated in FIG. 6. The bonding film was activated in this manner to develop adhesion to the bonding film surface.

Conditions of Plasma Treatment

Processing gas: Mixed gas of helium gas and oxygen gas

Gas supply rate: 10 SLM

Distance between electrodes: 1 mm

Applied voltage: 1 kVp-p

Voltage frequency: 40 MHz

Mobility rate: 1 mm/sec

Thereafter, the first base material and the second base material were mated to each other with the plasma contacted surface of the bonding film in contact with the surface of the second base material. The first base material and the second base material were then maintained at ordinary temperature (about 25° C.) for 20 seconds while applying a pressure of 50 MPa, so as to improve the bond strength of the bonding film for the second base material.

Then, the first base material and the second base material were separated from each other to transfer the bonding film of the first base material to the second base material.

Thereafter, a plasma was brought into contact with the bonding film transferred onto the second base material, using the atmospheric pressure plasma apparatus of FIG. 6 under the foregoing conditions. The bonding film was reactivated in this manner to develop adhesion to the bonding film surface.

Then, the second base material and the third base material were mated with each other with the plasma-contacted surface of the bonding film in contact with the surface of the third base material. The second base material and the third base material were then maintained at ordinary temperature (about 25° C.) for 20 seconds while applying a pressure of 50 MPa, so as to improve the bond strength of the bonding film for the third base material.

After these steps, a bonded structure was obtained in which the second base material and the third base material were bonded to each other via the bonding film patterned in the shape of the letter E.

The bond strength between the second base material and the third base material of the bonded structure was determined as 4 MPa or more by the measurement using a Romulus (Quad Group Inc.).

### Example 2

A bonded structure was obtained as in Example 1, except that a stainless steel substrate and a polyimide substrate were used as the second base material and the third base material, respectively, instead of the glass substrates.

As in Example 1, the bonding film was formed in the shape of the letter E (average thickness: about 100 nm; width of each line: 60 μm). The bond strength between the second base material and the third base material was 4 MPa or more.

### Example 3

A bonded structure was obtained as in Example 1, except that the bonding film was also formed over the whole surface on one side of the second base material and the third base material using the same liquid material used for the bonding film formed on the first base material, and that the second base material and the third base material with such bonding films were used.

As in Example 1, the bonding film was formed in the shape of the letter E (average thickness: about 100 nm; width of each line: 60 μm). The bond strength between the second base material and the third base material was 4 MPa or more.

What is claimed is:

1. A bonding method comprising:
(1) preparing a first base material, a second base material and a third base material, the first base material having a liquid repellency-imparted surface that is repellent against a silicone material-containing liquid material;
(2) applying the silicone material-containing liquid material to the liquid repellency-imparted surface of the first base material to form a liquid coating in patterns of a predetermined shape, and drying the liquid coating to obtain a bonding film patterned into the predetermined shape;
(3) imparting energy to the bonding film to provide adhesion near a surface of the bonding film, and thereafter bonding the first base material and the second base material to each other via the bonding film, and then separating the first base material and the second base material from each other to transfer the bonding film from the first base material to the second base material; and
(4) imparting energy to the bonding film after the transfer to provide adhesion near another surface of the bonding film, and bonding the second base material and the third base material to each other via the bonding film to obtain a bonded structure of the second base material and the third base material.

2. The bonding method according to claim 1, wherein, in step (2), the bonding film is formed over substantially an entire surface of the second base material to be bonded to the third base material.

3. The bonding method according to claim 1, wherein, in step (2), the bonding film is formed over substantially an entire surface of the third base material to be bonded to the second base material.

4. The bonding method according to claim 1, wherein, in step (2), the liquid coating is formed by supplying the liquid material in droplets using a droplet discharge method.

5. The bonding method according to claim 4, wherein the droplet discharge method is an inkjet method by which the liquid material is discharged in droplets through a nozzle hole of an inkjet head using vibration of a piezoelectric element.

6. The bonding method according to claim 1, wherein the predetermined shape corresponds in shape to a position where bonding by the bonding film is desired.

7. The bonding method according to claim 1, wherein the silicone material-containing liquid material includes a silicone material having a main backbone of polydimethylsiloxane, and wherein the main backbone is branched.

8. The bonding method according to claim 7, wherein at least one methyl group of the polydimethylsiloxane in the silicone material is substituted with a phenyl group.

9. The bonding method according to claim 1, wherein the silicone material-containing liquid material includes a silicone material including a plurality of silanol groups.

10. The bonding method according to claim 1, wherein the silicone material-containing liquid material includes a silicone material that is a polyester-modified silicone material obtained by a dehydrocondensation reaction with polyester resin.

11. The bonding method according to claim 10, wherein the polyester resin is the product of esterification reaction between saturated polybasic acid and polyalcohol.

12. The bonding method according to claim 1, wherein, in steps (3) and (4), energy is imparted to the bonding film by contacting a plasma with the bonding film.

13. The bonding method according to claim 12, wherein the contacting is performed under atmospheric pressure.

14. The bonding method according to claim 12, wherein the contacting is performed by supplying a plasma gas to the bonding film, wherein the plasma gas is produced by introducing a gas between opposing electrodes under applied voltage between the electrodes.

15. The bonding method according to claim 1, wherein portions of the second base material and the third base material that are brought into contact with the bonding film are primarily formed of a silicon material, a metal material, or a glass material.

16. The bonding method according to claim 1, wherein portions of the second base material and the third base material that will be brought into contact with the bonding film are subjected in advance to a surface treatment that improves adhesion for the bonding film.

17. The bonding method according to claim 16, wherein the surface treatment is a plasma treatment or an ultraviolet ray irradiation treatment.

18. The bonding method according to claim 1, further comprising subjecting the bonding film to a treatment that improves the bond strength between the second base material and the third base material, after the second base material and the third base material are bonded to each other.

19. The bonding method according to claim 18, wherein the treatment to improve the bond strength is performed by at least one of heating the bonding film, and exerting a compression force to the bonding film.

20. A bonding method comprising:
(1) providing a first base with a surface that is repellent against a liquid containing a silicone material;
(2) forming a bonding film on the first base by:
(a) applying the liquid to the surface of the first base to form a liquid coating in a predetermined shape on the surface; and
(b) drying the liquid coating to obtain a bonding film having the predetermined shape;
(3) transferring the bonding film from the first base to a second base by:
(a) providing adhesion along a first surface of the bonding film by imparting energy to the bonding film;
(b) thereafter bonding the first surface of the bonding film to the second base; and
(c) thereafter separating the bonding film from the first base; and
(4) obtaining a bonded structure of the second base and a third base by:
(a) after the transfer, providing adhesion along a second surface of the bonding film by imparting energy to the bonding film; and
(b) thereafter bonding the second surface of the bonding film to the third base.
